(19) United States
(12) Patent Application Publication
(10) Pub. No.: US 2026/0363489 A1
(43) Pub. Date: Nov. 19, 2026

(54) SYSTEM AND METHOD FOR AI-BASED MULTIMODAL COOKING CONTROL

(71) Applicant: Next Robot Inc., Chino Hills, CA (US)

(72) Inventors: Zhenyu Huang, Chino Hills, CA (US); Junyu Chen, Diamond Bar, CA (US); Jinyan Chen, Rowland Heights, CA (US); Renke Ma, Chino Hills, CA (US); Xiaochun Zhou, Chino Hills, CA (US)

(73) Assignee: Next Robot Inc., Chino Hills, CA (US)

(21) Appl. No.: 19/677,626

(22) Filed: May 14, 2026

Related U.S. Application Data
(60) Provisional application No. 63/807,092, filed on May 16, 2025.

(51) Int. Cl. A47J 44/00; A23L 5/10; A47J 36/32; B25J 11/00; G01J 5/00; G01J 5/10; G06V 10/143; G06V 10/82; G06V 20/50

(52) U.S. Cl. CPC A47J 44/00; A23L 5/10; A47J 36/32; G01J 5/10; B25J 11/0045; G01J 2005/0077; G05B 2219/32335; G05B 2219/39001; G06V 10/143; G06V 10/82; G06V 20/50

(57) ABSTRACT

A cooking system includes a cooking robot configured to perform cooking operations. The robot includes a plurality of sensors configured to collect data during the cooking operations, the data including one or more of thermal data or image data. A network interface enables communication between the cooking robot and a remote server. The server receives the data collected by the sensors, analyzes the data to determine a cooking state, and generates control instructions based on the cooking state. The system transmits the control instructions to the cooking robot to adjust the cooking operation. The system enables automated control of heating, stirring, or ingredient handling based on real-time analysis of sensor and image data. The server includes a memory storing a machine learning model configured to process time-series cooking data, image data, and ingredient information, and to output a cooking state used to drive control decisions.

### RELATED APPLICATION

This application claims the benefit of U.S. Provisional Application No. 63/807,092, filed May 16, 2025, the disclosure of which is incorporated herein by reference in its entirety for all purposes.

### BACKGROUND

Cooking, particularly in commercial or high-throughput environments, remains a largely manual and labor-intensive process. Tasks such as ingredient preparation, heat regulation, stirring, and determining doneness typically rely on human judgment and continuous supervision. These operations often use skilled personnel to ensure consistency, timing, and quality, which can lead to variability in output and increased labor costs, particularly in scenarios involving complex recipes or high-frequency service demands.

Various semi-automated cooking devices, including commercial stir-fry machines and industrial mixers, have been developed to reduce the need for manual stirring or heating control. However, such systems generally use frequent user intervention to manage timing, adjust temperatures, or visually assess ingredient readiness. These machines often rely on fixed control cycles or operator-defined timers, offering limited adaptability to changing ingredient behavior or environmental conditions. As a result, even with automation aids, cooking processes remain dependent on skilled oversight and do not fully address the challenges of consistency, scalability, or autonomous control.

### SUMMARY

A cooking system may include a cooking robot configured to perform one or more cooking operations. The cooking robot may include a plurality of sensors configured to collect data during the cooking operations, wherein the data includes one or more of thermal data or image data. The system may further include a network interface configured to enable communication between the cooking robot and a remote server. The remote server may be configured to receive the data collected by the plurality of sensors, analyze the data to determine a cooking state, and generate and transmit one or more control instructions to the cooking robot based on the determined cooking state.

A system for controlling a cooking process may include a memory storing executable instructions and a machine learning model, and a processor in communication with the memory. The machine learning model may include a first model component configured to receive and process time-series cooking data to generate a first feature representation, a second model component configured to receive and process image data captured during cooking to generate a second feature representation, and a third model component configured to receive ingredient information to generate a third feature representation. The system may further include a fusion component configured to combine the first, second, and third feature representations into a unified feature vector, and a classification component configured to receive the unified feature vector and generate an output indicating a cooking state.

Executing the instructions by the processor may configure the system to receive the time-series cooking data, the image data, and the ingredient information from a cooking device, determine the cooking state, and transmit one or more control instructions to the cooking device based on the cooking state.

A method for controlling a cooking process using a machine learning model may include receiving, by a server from a cooking device, time-series sensor data representing thermal and power conditions during a cooking session. The method may further include receiving, by the server, image data captured from one or more cameras oriented toward the cooking vessel of the cooking device, and receiving, by the server, ingredient information associated with the cooking session.

The method may include processing the time-series sensor data using a first model component to generate a first feature representation, processing the image data using a second model component to generate a second feature representation, and processing the ingredient information using a third model component to generate a third feature representation. The method may further include fusing the first, second, and third feature representations into a unified feature vector, inputting the unified feature vector into a classification component to generate an output indicating a cooking state, and transmitting, from the server to the cooking device, one or more control instructions based on the cooking state.

A method may include determining a selected amount of an ingredient to be dispensed; determining a dispensing duration based on a calibration parameter for the ingredient; actuating a dispenser for the dispensing duration; measuring, using a scale, a weight difference for the ingredient; determining a dispensed amount based on the weight difference; and adjusting the calibration parameter based on a difference between the selected amount and the dispensed amount.

A device may include a dispenser operable to dispense an ingredient; a scale operable to measure a weight difference for the ingredient; a processing device; and a memory storing executable instructions. The processing device may cause the device to: determine a selected amount of the ingredient to be dispensed; determine a dispensing duration based on a calibration parameter for the ingredient; actuate the dispenser for the dispensing duration; receive, from the scale, data representing the weight difference for the ingredient; determine a dispensed amount based on the weight difference; and adjust the calibration parameter based on a difference between the selected amount and the dispensed amount.

A cooking system may include a rotatable cooking vessel comprising a plurality of temperature sensors; a wireless communication device operable to transmit temperature data from the rotatable cooking vessel to a controller; and a plurality of heating sources, wherein the controller is operable to generate a spatial temperature profile of the rotatable cooking vessel.

A method may include receiving temperature readings from a plurality of temperature sensors coupled to a rotatable cooking vessel of a cooking system; determining angular positions for the temperature readings; and generating a spatial temperature profile of the rotatable cooking vessel based on the temperature readings and the angular positions.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is noted, however, that the appended drawings illustrate only some aspects of this disclosure and the disclosure may admit to other equally effective embodiments.

To facilitate understanding, identical reference numerals have been used, where possible, to designate identical elements that are common to the figures. It is contemplated that elements and features of one embodiment may be beneficially incorporated in other embodiments without further recitation.

FIG. 1 illustrates an exemplary cooking system;

FIGS. 2A-2D illustrate an exemplary cooking robot for use in the cooking system shown in FIG. 1;

FIGS. 3A-3C illustrate example process flows implemented by the cooking system shown in FIG. 1;

FIGS. 3D-1 and 3D-2 illustrate example heating-power profiles over time during a cooking session;

FIG. 4 depicts an exemplary learning model for implementing an exemplary cooking system; and

FIGS. 5A-5C depict example process flows implemented by the cooking system shown in FIG. 1.

FIGS. 6A-6G illustrate example ingredient dispensers for use in a cooking system.

FIGS. 7A-7B illustrate example rotatable cooking vessels for use in a cooking system.

FIG. 8 illustrates an example method for controlling a cooking process using a machine-learning-based multimodal cooking-control system.

FIG. 9 illustrates an example method for calibrating an ingredient dispenser.

FIG. 10 illustrates an example method for generating a spatial temperature profile.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more embodiments herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Embodiments described as being implemented in hardware should not be limited thereto, but can include embodiments implemented in software, or combinations of software and hardware, and vice-versa, as will be apparent to those skilled in the art, unless otherwise specified herein. In the exemplary embodiments described herein, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The examples described below provide an intelligent cooking system that utilizes multimodal data inputs to control and optimize the execution of cooking processes, such as stir-frying. The system may comprise a cooking robot equipped with environmental sensors and/or a camera system, and a remote or embedded server that includes an artificial intelligence (AI) engine configured to analyze real-time data streams. The system may collect time-series thermal and power data, visual data from red green blue (RGB) and/or thermal imaging, and ingredient metadata, and may process this data using a hybrid neural network architecture comprising a Long Short-Term Memory (LSTM) model and a Convolutional Neural Network (CNN). Outputs from the AI model may be used to determine cooking states and to drive real-time adjustments to parameters such as heat application, stirring, tilt angle, ingredient feeding, and cooking duration.

The neural network may integrate sequential sensor data, visual embeddings, and encoded ingredient characteristics to infer cooking progress with improved accuracy and robustness. The LSTM model may capture the temporal evolution of cooking variables such as temperature and power usage, while the CNN may detect ingredient-specific visual cues related to color, texture, and doneness. These features may be fused with ingredient vectors to generate a composite cooking state representation, which may be evaluated by a classification layer to determine whether a target cooking state has been achieved. Based on this inference, the system may automatically trigger transitions between cooking phases, adjust mechanical operations, or conclude the cooking process.

The disclosed system may enable data-driven automation of traditionally manual cooking tasks and supports adaptive behavior under varying environmental conditions or ingredient loads. The architecture may support extensibility to different ingredient types and recipes, and may be trained or updated using labeled visual and sensor datasets to further enhance accuracy. By combining AI-based inference with sensor fusion and physical actuation, the system may provide a novel, closed-loop cooking control platform capable of delivering consistent and optimized culinary outcomes.

By fusing data from sensors, cameras, and ingredient inputs, the system may make real-time decisions that control the cooking robot, optimizing heating, stirring, and ingredient addition. Additionally, the system may provide a user interface for customization and learning from user feedback, further enhancing cooking accuracy over time.

In addition, automated cooking systems may include dispensers for sauces, oils, seasonings, powders, granules, or other ingredients. In some systems, an amount of ingredient dispensed may be estimated based on a dispensing duration. However, a fixed duration-to-amount relationship may become inaccurate over time due to changes in ingredient density, particle size, viscosity, moisture content, settling, clumping, pump performance, or mechanical wear of the dispenser. As a result, a recipe calling for a selected amount of salt, sauce, oil, or other ingredient may receive an inaccurate amount, reducing consistency between cooking sessions.

The cooking system may include an ingredient dispensing calibration system. The system may determine a selected amount of an ingredient to be dispensed, determine a dispensing duration based on a calibration parameter associated with the ingredient, actuate a dispenser for the dispensing duration, measure a weight difference using a scale, determine an actual dispensed amount based on the weight difference, and adjust the calibration parameter based on a difference between the selected amount and the actual dispensed amount. The dispenser may include a pump for a liquid ingredient or a gravity-fed dispenser, gate, valve, auger, screw conveyor, vibration feeder, chute, or other dispensing mechanism for a dry ingredient.

In addition, cooking robots may also rely on a single temperature sensor or a limited number of fixed temperature sensors positioned relative to the pot. Such arrangements may provide only partial temperature visibility, particularly where the cooking vessel rotates or where cold ingredients create localized thermal gradients. A single temperature value may not accurately represent the thermal condition of the vessel surface or the distribution of heat across the vessel. This can limit the ability of the controller or machine-learning model to compensate for localized cooling or uneven heating.

The cooking system may include a rotatable cooking vessel having a plurality of temperature sensors coupled thereto. Temperature data from the sensors may be transmitted wirelessly or through another communication interface to a controller. The controller may associate the temperature readings with angular positions of the rotatable cooking vessel and generate a spatial temperature profile of the vessel. The spatial temperature profile may be used to control one or more heating sources, including multiple independently controllable heating sources, and may be provided as an input to a machine-learning model, such as an LSTM model, to determine a cooking state.

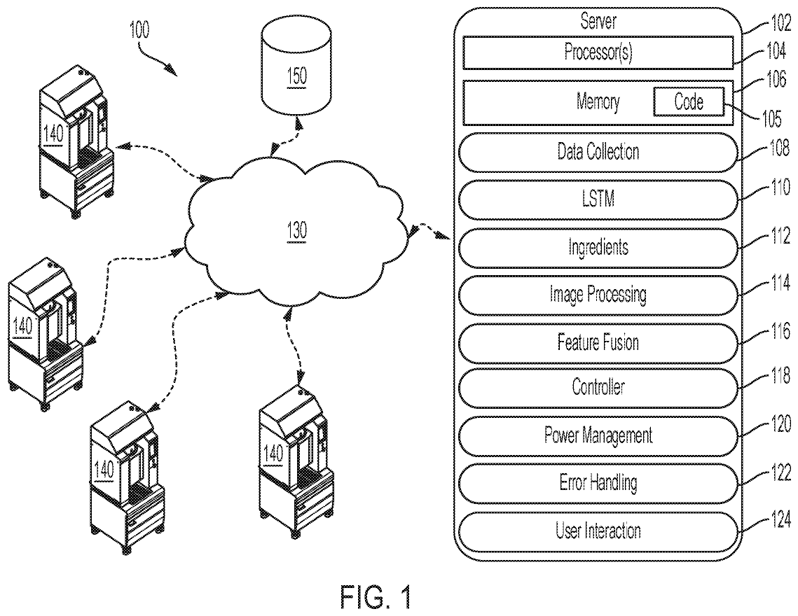

Referring now to FIG. 1, FIG. 1 illustrates an exemplary AI-powered cooking robot system 100 (hereinafter “system 100”) where multiple cooking robots 140 may interact with a remote server 102 via a network 130. Server 102 may process real-time data received from the cooking robots and may provide commands based on sophisticated AI algorithms. Remote resources 150 may supplement server 102 with additional computational capabilities, such as cloud-based processing or data storage.

Described in detail below, cooking robots 140 may be equipped with sensors and cameras that collect data about the cooking process, such as temperature, power usage, and visual information. Such data may be transmitted through network 130 to server 102, which may host various program modules responsible for analyzing the data and making real-time adjustments to the cooking process.

Server 102 may provide the central control unit (e.g., processor 104) that processes data from the cooking robots and provides real-time decisions. Server 102 may house AI modules, including data processing, decision-making, and control algorithms. Processor(s) 104 may execute complex computations, and the memory 106 may store software code 105 and data to run the system effectively. Server 102 may be capable of handling multiple cooking robots simultaneously and may ensure that each robot receives precise, real-time commands to optimize the cooking process. Processor(s) 104 may be configured to receive and execute software code 105 for implementing the system described herein.

Remote resources 150 may include cloud-based or external computing resources that provide additional processing power and storage. For example, when the processing load exceeds the capacity of server 102, system 100 may offload certain computations or data storage tasks to the remote resources 150. Such offloading may enable system 100 to handle larger datasets (e.g., scaling to 1000's of cooking robots, complex cooking scenarios) and maintain performance without sacrificing accuracy.

Network 130 may include communication infrastructure connecting the cooking robots 140 with server 102 and remote resources 150. Network 130 may facilitate data exchange between cooking robots 140 and server 102 in real time, ensuring that commands and sensory feedback are transmitted without delay. Network 130 may be advantageous for real-time control and decision-making, as it allows server 102 to analyze data and send back commands to adjust the cooking process on the fly.

Network 130 may include, for example, a local area network (LAN)/wide area network (WAN) connection configured to provide an Internet connection via a hybrid fiber optic (HFC) transmission network, (e.g., Ethernet twisted shielded pair CAT-5, WiFi, premises coaxial cable network, or any other connection capable of establishing an Internet connection). Network 130 may include a wireless network capable of establishing an internet connection (e.g., 5G, long term evolution (LTE), 4G, code division multiple access (CDMA), and the like). Network 130 may facilitate leveraging external resources 150 for facilitating various functionality, which is described in further detail below.

External resources 150 may include a remote database and/or access to 3^{rd} party Application Programming Interface (API) services that facilitates the integration and interaction between system server 102, and a remote client (e.g., 140, 150), with external systems and resources for enhanced functionality. For example, resources 150 may facilitate connection with a variety of 3rd party API services, enabling the system to leverage external tools and data sources. External resources 150 may establish connections with one or more remote databases (not shown), which may be advantageous in augmenting system 100 data handling and processing capabilities. By implementing external resources 150, system 100 may advantageously expand the range of functionalities, such as real-time data analysis. Such external resources 150 not only enriches the user experience by providing more accurate and efficient outcomes but also enhances the overall system's performance by integrating virtualization techniques for streamlining process efficiency, which is described in detail further below.

Server 102 may include a plurality of functional modules configured to receive, analyze, and respond to sensory input from one or more cooking robots 140 over network 130. The modules may include data collection module 108, LSTM module 110, ingredients module 112, image processing module 114, feature fusion module 116, controller module 118, power management module 120, error handling module 122, and user interaction module 124.

Data collection module 108 may be configured to receive sensory data from cooking robots 140. The sensory data may include temperature measurements, power usage metrics, ingredient-related information, and visual image data from one or more cameras disposed on the cooking robot 140. Data collection module 108 may be further configured to perform preprocessing operations, such as timestamp alignment, normalization, filtering, and imputation for incomplete data. The module may ensure time-series data and image data streams are synchronized prior to analysis by downstream processing modules.

LSTM module 110 may implement a Long Short-Term Memory neural network trained to analyze time-series sensor data, such as heating element power levels and temperature fluctuations. Based on the observed data, LSTM module 110 may generate a hidden state vector representing the thermal behavior of the cooking session. The output of LSTM module 110 may be used to dynamically adjust the heat profile applied to the cooking robot 140, thereby enabling adaptive cooking behavior based on temporal patterns.

Ingredients module 112 may be configured to receive ingredient-related data, such as ingredient type, mass, volume, and predefined cooking attributes. The data may be encoded using one-hot or other suitable categorical encoding methods. Ingredients module 112 may output a representation of the ingredients as a vector, which is used in conjunction with other data streams for predictive modeling and control. The module may enable ingredient-aware control logic, allowing for the differentiation of cooking strategies based on ingredient characteristics.

Image processing module 114 may receive visual input from RGB or thermal cameras integrated with cooking robot 140. The module may extract one or more visual features from the input, including, but not limited to, ingredient color, texture, browning, smoke presence, and moisture level. Image processing module 114 may utilize a convolutional neural network (CNN) to perform real-time classification or feature extraction. The extracted features may serve as indicators of doneness or cooking stage progression.

Feature fusion module 116 may be configured to combine feature vectors generated by LSTM module 110, ingredients module 112, and image processing module 114. The fusion process may include projection into a common feature space, dimensional alignment, and vector concatenation. The resulting unified feature vector may represent a composite state of the ongoing cooking process. The fused feature vector may be provided to controller module 118 for decision-making operations.

Controller module 118 may receive input from feature fusion module 116 and may determine one or more control actions to be executed by cooking robot 140. The control actions may include adjustments to heating element power, stirring frequency, cooking duration, or ingredient addition timing. Controller module 118 may generate and transmit command signals to cooking robot 140 via network 130. Controller module 118 may perform continuous feedback control based on evolving sensory input.

Controller module 118 may control a plurality of heating sources based on the spatial temperature profile. The controller may independently adjust power levels, duty cycles, timing, phase, or activation states of the heating sources to achieve a desired thermal state. The desired thermal state may include uniform vessel temperature, a recipe-specific thermal gradient, rapid recovery after ingredient addition, reduced overheating in a localized region, or improved energy efficiency.

Power management module 120 may monitor environmental constraints, such as available power supply at a given deployment site. Based on such constraints, power management module 120 may adjust heating profiles, reduce peak power demand, or switch to energy-efficient operational modes. The module may optimize power usage without substantially affecting cooking performance. For example, in conditions where maximum power availability is reduced, the module may adjust heating duration while maintaining temperature targets.

Error handling module 122 may be configured to detect anomalies, sensor malfunctions, or communication failures in real time. When missing or corrupted data is detected, the module may apply data imputation techniques (e.g., forward fill, backward fill, or interpolation) to maintain continuity. In the event of hardware errors, error handling module 122 may issue fallback instructions, trigger alerts, or initiate a safe shutdown of the affected cooking robot 140.

User interaction module 124 may provide a user interface enabling operator input, such as preferred doneness levels, ingredient customizations, or recipe selection. The module may also receive user feedback following completion of a cooking session. User interaction module 124 may be configured to update internal models or parameters based on user input, thereby enabling system personalization and continuous learning.

One or more components of system 100 (e.g., cooking robot 140, processors 104, and/or modules 108, 110, 112, 114, 116, 118, 120, 122, and 124) (collectively “modules 108-124”) may be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs (e.g. code 105) that are executable and/or interpretable on a programmable system including one or more programmable processor(s) (e.g. 104), which can be special or general purpose, coupled to receive data and instructions from, and to transmit data and instructions to, a storage system (e.g., memory 106), at least one input device, and at least one output device. The programmable system or computing system may include clients (e.g., system 100) and servers (e.g., 102). A client and server are generally remote from each other and typically interact through a communication network (e.g., 130). The relationship of client and server arises by virtue of computer programs running on the respective computers and having a client-server relationship to each other.

Such computer programs, which can also be referred to programs, software, software applications, applications, components, or code (e.g., 105), include non-transitory machine readable instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

Cooking robot 140 may comprise one or more actuators, sensors, and cooking components configured to execute heating, stirring, and ingredient-handling operations under control of server 102. Discussed in detail below, cooking robot 140 may include embedded temperature sensors, power consumption monitors, cameras (e.g., RGB and/or thermal), stirring mechanisms, and/or ingredient dispensers. Sensor data collected by cooking robot 140 may be transmitted to server 102 over network 130. Server 102, in turn, may issue control instructions to cooking robot 140 to carry out adaptive cooking behaviors based on processed data and AI-driven decision logic, which is discussed in further detail below.

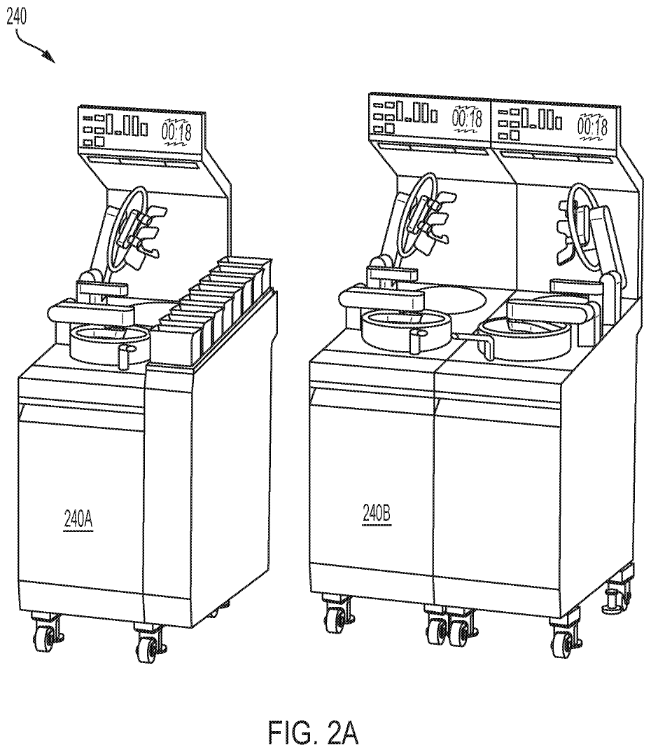

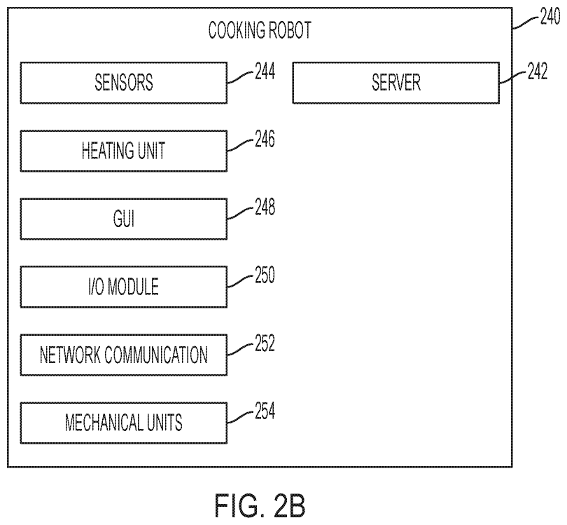

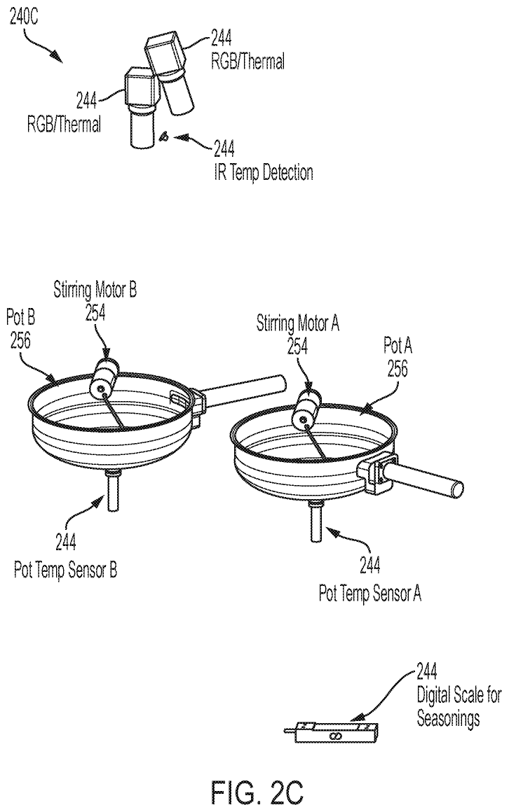

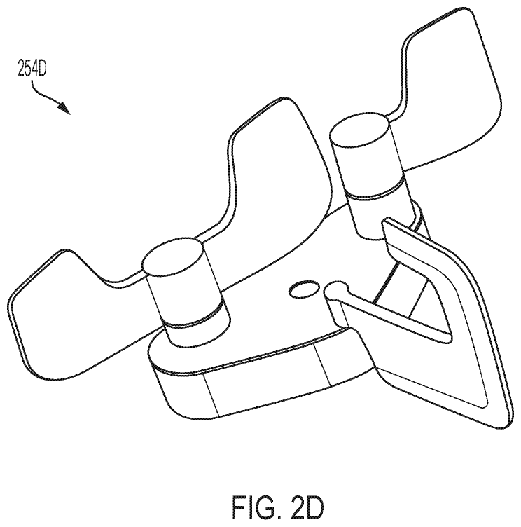

Referring now to FIGS. 2A-2D, in conjunction with FIG. 1, FIG. 2A depicts cooking robot 240. As shown in FIG. 1, cooking robot 240 may communicate with server 102 via network 130 to receive control instructions and transmit real-time sensory data for processing. The structural configuration of cooking robot 240 may be depicted in two exemplary hardware variations, labeled 240A and 240B, shown in FIG. 2A. The internal subsystems and component relationships may be diagrammatically represented in FIG. 2B, while FIG. 2C may illustrate the sensor and mechanical layout relative to the cooking vessels. FIG. 2D provides an enlarged view of one example stirring mechanism associated with mechanical units 254.

Cooking robot 240 may include an integrated processing system comprising server 242, sensors 244, heating unit 246 (which may include one or more heating sources), graphical user interface (GUI) 248, input/output (I/O) module 250, network communication interface 252, and one or more mechanical units 254. These components may be housed within a mobile or fixed housing structure as shown in examples 240A and 240B.

### Exterior Hardware Configurations

As shown in FIG. 2A, cooking robot 240A may include a single active cooking station with a single pot and an array of ingredient compartments disposed adjacent the pot. In contrast, cooking robot 240B may comprise a dual-station layout with two separate cooking vessels disposed side by side, allowing concurrent preparation of multiple dishes. GUI 248 may be positioned above the cooking stations and may display information related to recipe status, time remaining, power consumption, or cooking phase indicators. Such physical enclosures may provide mounting points for integrated sensors 244 and mechanical units 254 described in further detail below. Different configurations of cooking robot 240A, 240B (collectively “cooking robot” 240) may share the same or similar control and sensing architecture while varying in capacity or layout.

FIG. 2B depicts the functional subsystem overview for cooking robot 240. Server 242 may be an integrated processing system, local microcontroller or embedded processing unit configured to execute instructions received from server 102, including control signals generated by controller module 118. The cooking robot may optionally include fallback or redundant routines for basic operations in the event of network disruption.

Any feature, function, or module described as being executed by server 102 may alternatively or additionally be implemented by server 242 located at the cooking robot level, or delegated to a remote server having greater computational capacity. For example, real-time inference, sensor data processing, or control logic may be performed locally by server 242 to support low-latency operation, while server may handle higher-level functions such as model training, long-term learning, or cloud-based orchestration. Server 102 may function as an intermediary, coordinating between edge-level control and remote computation. The architecture may be designed to be flexible and modular, allowing system components to operate in a distributed manner depending on compute availability, latency, connectivity, or desired deployment configuration. Accordingly, any feature described with respect to one server may be executed in whole or in part by another, including server 102, server 242, or another remote, local, or distributed processing device.

Sensors 244 may include temperature sensors, image capture devices (e.g., RGB cameras, infrared cameras), load sensors, and environmental detectors (e.g., humidity sensors, smoke detectors). Heating unit 246 may be configured to provide variable thermal energy to the cooking vessel(s) in response to system input. GUI 248 may provide interactive feedback to a human operator and may optionally accept user inputs such as manual overrides or preference selections.

The I/O module 250 may manage interconnections between internal subsystems, including power regulation and actuator controls. Network communication interface 252 may include a wireless or wired transceiver configured to establish a bidirectional communication link with server 102 over network 130. Mechanical units 254 may include motors, actuators, and custom components that control stirring, pot rotation, ingredient dispensing, or lid manipulation.

### Sensor and Mechanical Layout

As shown in FIG. 2C, cooking robot 240C may include two cooking vessels, labeled pot A and pot B. Each pot may be associated with a dedicated set of sensors 244 and mechanical units 254 to enable independent control and monitoring.

Such mechanical units 254 may include stirring motors A and B, which may be coupled to stirring assemblies disposed within each pot and may be configured to rotate stirring implements, such as blades or paddles (e.g., 254D), during cooking. An enlarged view of an exemplary stirring blade assembly 254 is shown in FIG. 2D. Individual pots (or each pot) may include one or more temperature sensors 256, labeled pot temperature sensor A and pot temperature sensor B, respectively. Sensors 256 may include embedded thermocouples or digital thermistors disposed in direct contact with the base of the cooking vessel to capture real-time internal temperature readings. These temperature values may be transmitted to data collection module 108 for preprocessing and subsequently analyzed by LSTM module 110 to predict optimal heating curves and inform power adjustments, which is described in further detail below.

One or more AI cameras (e.g., AI cameras A and B), identified as part of sensors 244, may be mounted above the cooking vessels to capture high-resolution RGB and/or infrared (IR) visual data during operation. One AI camera may capture two or more cooking vessels. The image data may be transmitted to image processing module 114, which may extract features such as ingredient browning, texture changes, steam, or particulate detection. An additional IR temperature detection sensor may be mounted in a non-contact orientation above the cooking zone to provide supplementary surface temperature data of the ingredients during active heating.

The infrared temperature sensor, RGB camera, and/or thermal camera may be mounted on the upper region of the cooking robot housing, oriented downward toward the cooking vessel, as shown. Such top-mounted configuration may enable the sensors to maintain an unobstructed view of the ingredients throughout the cooking process.

Advantageously such infrared sensor(s) may be configured to capture non-contact surface temperature readings from the ingredients in the pot. In parallel, the RGB camera and/or thermal camera capture visual and thermal imagery of the food surface, allowing real-time detection of color change, texture, steam, and browning. The top-mounted positioning may ensure focal alignment, minimize occlusion by steam or mechanical parts, and allow for direct observation of cooking effects such as bubbling, shrinkage, or fragmentation. These top-mounted sensors may be housed within a protective enclosure featuring a transparent, heat-resistant cover and may include a lens cleaning mechanism to ensure visibility under high-moisture cooking conditions.

The cooking robot may include two distinct modalities for measuring pot temperature: (i) a base-mounted contact temperature sensor disposed beneath or within the wall of the cooking vessel, and/or (ii) a top-mounted infrared temperature sensor oriented toward the surface of the ingredients within the pot. For example, the contact sensor may provide direct, localized temperature measurements at the base of the cooking vessel, while the infrared sensor may measure surface temperature without physical contact. These two signals may be used independently or in combination to assess thermal gradients, heat distribution, or ingredient-specific thermal behavior during cooking.

Cooking robot 240C may further include a digital scale configured for measuring seasoning quantities dispensed into the cooking vessel. This scale may operate in conjunction with the ingredient dispensing mechanism and may serve as an input to ingredients module 112, allowing the system to record actual ingredient quantities for improved AI modeling.

Ingredient-related data may include dispenser calibration data. The dispenser calibration data may include a calibration parameter, flow-rate estimate, historical dispensing error, ingredient density estimate, viscosity estimate, particle-size-related estimate, or confidence value associated with an ingredient dispenser. The ingredients module 112 may use the calibration data to determine an actual amount of ingredient dispensed, update an ingredient vector, modify a recipe state, or improve subsequent cooking-state inference.

Sensors 244 may be distributed across multiple sensing domains including one or more of: thermal sensing domain: pot temperature sensors 256, IR temperature detection sensors; visual sensing domain: AI cameras A and B (RGB and/or thermal). Motion and control domain; motor encoders and positional sensors associated with stirring motors A and B mass and volume sensing, and/or digital scale for seasoning and additional load cells under the cooking vessels.

Mechanical units 254 may include stirring motors that may include one or more motor current sensor(s) configured to monitor the electrical current drawn by the stirring mechanism during operation. The motor current sensor may be integrated into the stirring motor driver circuitry or may be measured indirectly via a current sensing module. Such feedback signal may reflect the mechanical resistance encountered during stirring and may be used as an indirect indicator of ingredient toughness, density, or cooking stage. For example, increased current draw may correspond to denser or uncooked food, while reduced current may indicate softening or breakdown of structure.

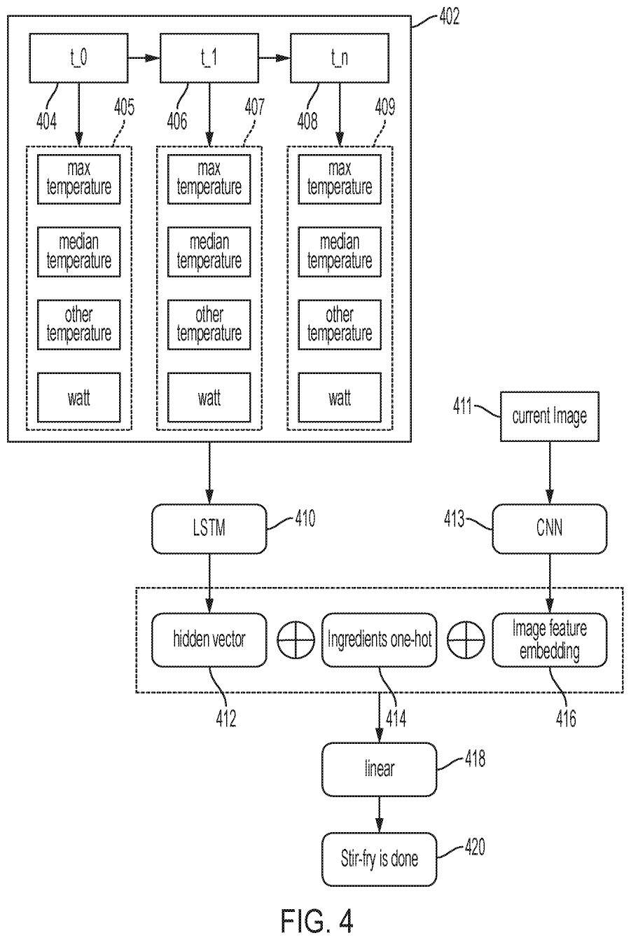

This current feedback may be transmitted to server 102 via data collection module 108 and may be included in the time-series data analyzed by LSTM module 410 (see FIG. 4). The data may be preprocessed to normalize for baseline motor behavior and may be encoded as part of the system's multimodal input vector.

Data from such sensors 244 may be streamed to server 102 for analysis. For example, the time-series data processed by LSTM module 410 may include not only temperature and power output data, but also current feedback from the stirring motor, as discussed above. The motor current signal may be sampled at regular intervals to track mechanical resistance during cooking, allowing the model to infer changes in food texture or phase transitions (e.g., from raw to soft or from whole to fragmented). Such input may enhance the model's ability to detect ingredient readiness and may contribute to cooking state inference via output 420.

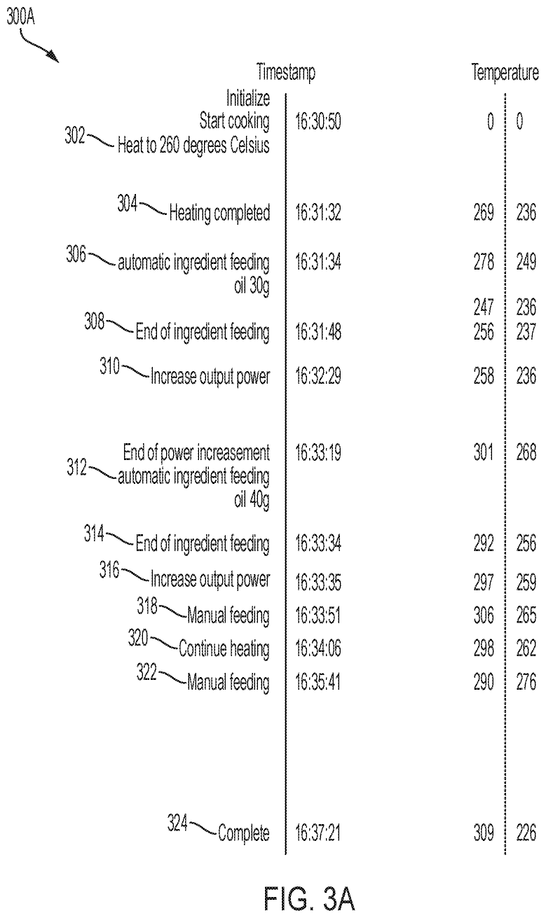

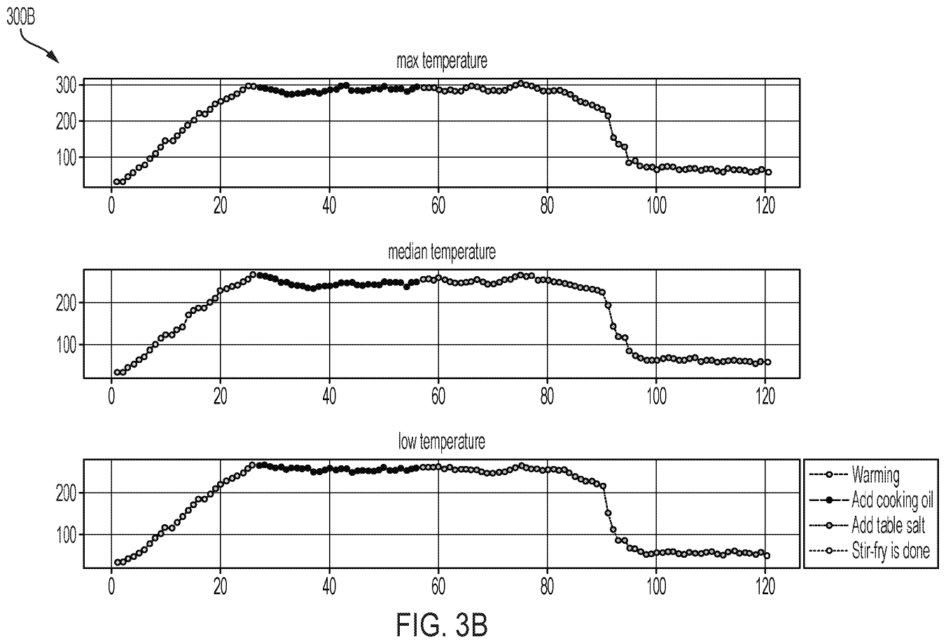

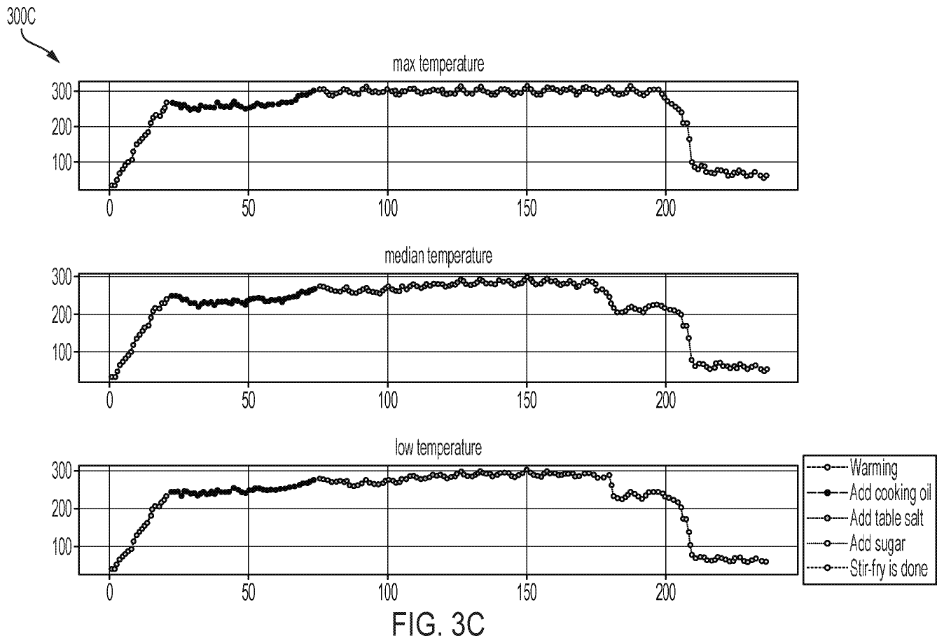

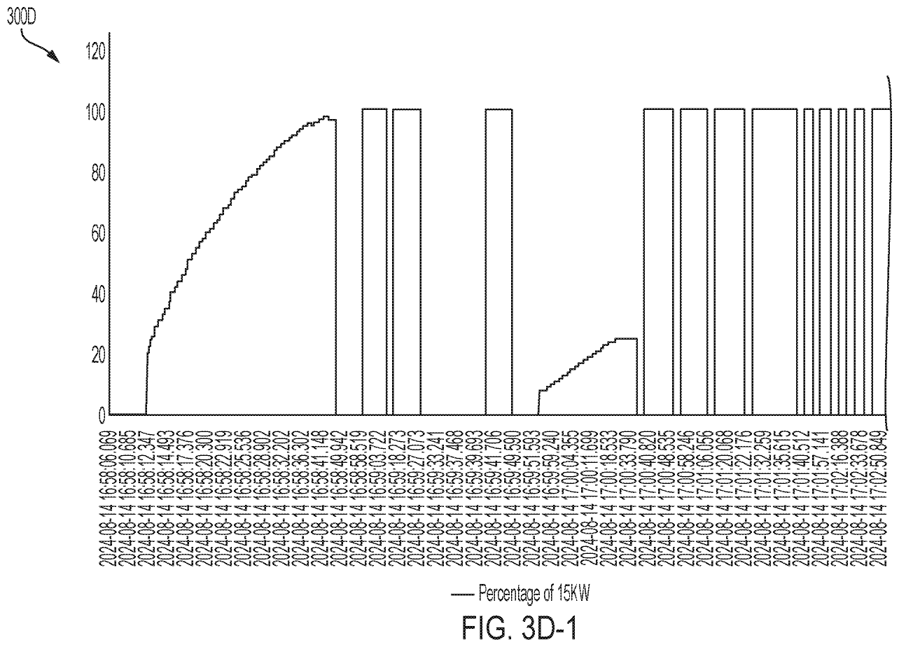

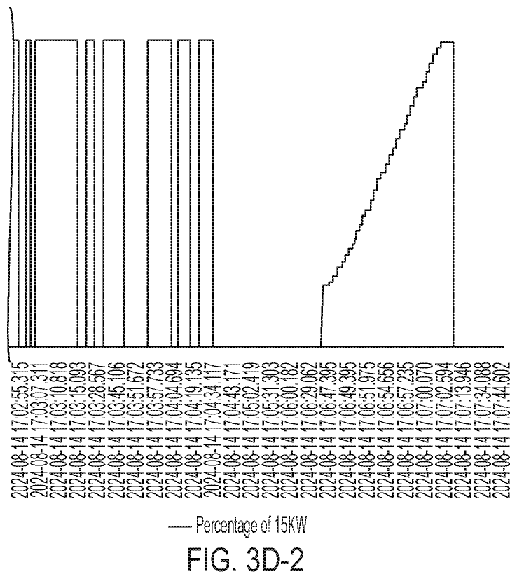

The combination of thermal, visual, and/or ingredient-specific data may enable the AI embedded into system 100 to assess cooking progress, predict completion states, and trigger control events such as heating rate adjustments or phase transitions, which is discussed in detail further below in connection with FIGS. 3A-3D and FIG. 4.

As shown in FIG. 2D, some implementations may include a stirring assembly 254D. Stirring assembly 254D may include one or more curved paddles or fins attached to a central axle. The paddles may be designed to conform to the internal geometry of the cooking vessel, promoting uniform ingredient agitation and reducing stagnation zones. The geometry of the blade assembly of stirring assembly 254D may vary depending on the cooking mode or target ingredient type and may be interchanged based on operations.

Blade rotation speed, duration, and direction may be dynamically controlled by server 102 in response to sensor data and cooking stage, allowing for precision control over mechanical mixing during frying, simmering, or final stir-down phases.

Referring now to FIG. 3A-3C in conjunction with FIG. 1, FIGS. 3A-3C depict graphical representations illustrating exemplary cooking sequences 300 executed by cooking robot 240 under the control of server 102. Such cooking sequences 300 may be generated using real-time sensor feedback and adaptive control algorithms implemented by controller module 118. As described above with reference to FIGS. 2A-2D, cooking robot 240 may include sensors 244 such as pot temperature sensors 256, infrared thermal sensors, and cameras, which may collectively enable precise, multi-phase monitoring of the cooking process. The system may use this data to execute multi-operation stir-fry or sauté processes, adjusting heat, ingredient addition, and stirring phases accordingly.

FIG. 3A shows a timeline-based sequence of events captured during an example cooking process 300A. A timestamp column indicates key operational events and transitions alongside recorded temperature values for two separate cooking zones or measurement points. These measurements may correspond to sensor data from two distinct locations within a single cooking pot or from two separate pots (e.g., pot A and pot B as shown in FIG. 2C). The event progression may include automated ingredient feeding (e.g., oil addition), power adjustments, and transitions into or out of heating phases. These events may be driven by input from sensors 244 and logic residing in modules such as data collection module 108, LSTM module 110, and ingredients module 112.

The timeline based sequence of events may include a number of operations including: heating to 260 degrees Celsius, as shown in operation 302; completing heating, as shown in operation 304; automatic ingredient feeding of 30 g of oil, as shown in operation 306; end of ingredient feeding, as shown in operation 308; increasing output power, as shown in operation 310; ending of power increase and automatic ingredient feeding of 40 g of oil, as shown in operation 312; end of ingredient feeding, as shown in operation 314; increasing output power, as shown in operation 316; manual feeding, as shown in operation 318; continuing of heating, as shown in operation 320; manual feeding, as shown in operation 322; and/or completion, as shown in operation 324.

The temperature responses shown in FIG. 3A reflect both transient and steady-state thermal behavior, which the system interprets in real time to determine process advancement. For instance, after the addition of 30 g of oil at 16:31:34, a cooling response is detected (278 °C to 247 °C), prompting a power increase to reestablish target temperatures.

Referring to FIG. 3B, time-series plots 300B are presented for maximum, median, and low temperatures captured during a single cooking session. Each subplot corresponds to a different statistical aggregation of temperature readings from sensor array 244. Data from multiple temperature sensors 256 may be used to compute these values at each time interval.

As shown, the cooking process may be segmented into multiple operational phases. For example, some segments represent the warming phase, where heating unit 246 may be activated to raise the temperature of the cooking pot to a pre-specified level. Upon reaching the temperature target (e.g., ~290 °C), the system enters a phase corresponding to the addition of cooking oil. This transition may be automatically triggered when the temperature stabilizes at a predefined range, as detected by data collection module 108.

Other segments may indicate the sustained cooking phase following the addition of salt, sugar, or other seasonings. During this phase, the AI system may maintain a steady heat output or dynamically adjust it based on ingredient behavior, pot load, and thermal feedback. Notably, the transition into this phase may be based on temperature thresholds, visual data from image processing module 114, or predictions from LSTM module 110.

Referring to FIG. 3C, additional time-series plots 300C are shown, representing a different cooking routine involving additional seasoning stages. Here, multiple operational transitions are depicted: warming, oil addition, salt addition, sugar addition, and process completion. Each of these transitions may correspond to predefined rules or thresholds, or may be triggered by AI-based inference.

The consistency of temperature during the salt addition and sugar addition phases illustrates the system's ability to maintain controlled cooking temperatures even in the presence of active ingredient additions. The slight fluctuations may be expected due to thermal shock during feeding events, which may be compensated for in real time by controller module 118 using fused data inputs from LSTM module 110, ingredient vector analysis from module 112, and optionally visual confirmation from image processing module 114.

Referring to FIGS. 3D-1 and 3D-2, another plot 300D is shown, representing different power levels over time as a percentage of 15 kW. FIG. 3D-1 depicts a first portion of the power-control profile, and FIG. 3D-2 depicts a continuation of the same profile over a later time period. As shown in FIGS. 3D-1 and 3D-2, the power level may vary over time in response to recipe phase, sensor feedback, ingredient addition, temperature recovery behavior, and/or control instructions generated by controller module 118. For example, controller module 118 may increase the power level during a preheating phase or following addition of cold ingredients, and may reduce or modulate the power level after a target temperature, target thermal profile, or predicted cooking state has been reached.

The power values represented in plot 300D may be included in the time-series cooking data processed by LSTM module 410. The LSTM module may analyze the power-control profile together with temperature data, motor-current feedback, image-derived features, and ingredient information to determine a cooking state or predict a subsequent cooking transition.

Across these examples, the system may adapt cooking sequences in real time to match recipes, environmental conditions (e.g., power availability), and sensory feedback. These figures demonstrate how sensor data is not only collected but also processed to drive dynamic power control, ingredient timing, and temperature optimization. The methods shown in FIGS. 3A-3C may be executed based on the hardware configuration described above in FIGS. 2A-2D and the system architecture introduced in FIG. 1. The underlying computational methods for analyzing these temperature curves, performing phase detection, and executing predictive control are described in further detail below with reference to FIG. 4.

Referring now to FIG. 4 in conjunction with FIGS. 1-3, FIG. 4 depicts neural network architecture 402 operable for processing multimodal cooking data to determine cooking status, in particular, whether a stir-fry process is complete. Architecture 402 may be implemented within server 102 and may operate in conjunction with the modules previously described in FIG. 1, including LSTM module 110, image processing module 114, ingredients module 112, and feature fusion module 116. The architecture 402 may be used to analyze data collected by data collection module 108 from sensors 244 of cooking robot 240 (see FIGS. 2A-2C), and may assist in executing the adaptive cooking methods shown in FIGS. 3A-3C.

### Temporal Sensor Input and LSTM Encoding

At the upper-left portion of FIG. 4, a time-series input sequence is illustrated, comprising timestamped feature vectors 404, 406, and 408, collectively spanning a sequence from t₀ to tₙ. Each timestamp vector may contain a set of features 405, 407, and 409 respectively, which may include: maximum temperature (e.g., from pot temperature sensor 256), median temperature (e.g., statistical median across multiple sensor readings), other temperature (e.g., minimum or IR-based surface temperature), and/or power usage (e.g., wattage data from heating unit 246). Such time-series data may be collected at regular intervals (e.g., every 2 seconds) by data collection module 108 and may represent the evolving thermal and electrical behavior of the cooking robot 240 during a cooking session.

The time-series data may be passed into a Long Short-Term Memory (LSTM) neural network 410, which may encode the sequential data into a hidden vector 412. The LSTM model may be configured to capture short- and long-term dependencies in the data, enabling recognition of patterns such as temperature stabilization, post-ingredient cooling dips, and energy usage signatures. LSTM module 410 may correspond to LSTM module 110 in FIG. 1 and may operate based on models trained using previously executed cooking sessions, including sessions recorded using the configurations of FIGS. 2A-2C and the thermal sequences of FIGS. 3A-3C.

Parallel Image Processing with CNN

In parallel with the LSTM stream, a current image 411 captured by one or more AI cameras (see sensors 244 in FIG. 2C) may be fed into a Convolutional Neural Network (CNN) 413. The CNN 413 may correspond to image processing module 114 in FIG. 1 and may be configured to extract features relevant to ingredient doneness, surface browning, moisture evaporation, smoke presence, or color saturation. The output of CNN 413 may be a dense image feature embedding 416, representing the visual state of the cooking process.

### Ingredient Encoding and Fusion

A categorical representation of the active ingredients in the recipe is provided as an ingredient vector 414, which may use one-hot encoding to identify key ingredients (e.g., meat, tofu, vegetables) and optionally modifiers such as quantity, density, or preparation method. This may correspond to the functionality of ingredients module 112.

The hidden vector 412 (from LSTM), ingredient encoding 414, and image embedding 416 may be concatenated or otherwise fused in a feature fusion layer. This fused vector may correspond to the unified representation produced by feature fusion module 116 of FIG. 1. For example, feature fusion module 116 may be configured to construct a joint feature space by combining a plurality of data modalities into a unified feature vector. The fused modalities may include, one or more of: (i) infrared surface temperature readings of the cooking pot; (ii) power output values from the heating element; (iii) image feature embedding extracted from RGB or thermal image data; and/or (iv) ingredient feature vectors derived from ingredient type, quantity, and/or characteristics.

Feature fusion 116 may perform concatenation, projection, or weighted normalization across these feature domains to align them into a common vector space. Such unified representation may then be used by classification layer 418 to determine the current cooking state, such as ingredient doneness or phase completion. Fusion across heterogeneous inputs may allow system 100 to contextualize real-time sensor signals with visual and semantic cues for more accurate control decisions.

The fused feature vector may be input into a linear classification layer 418, which may output a final prediction output 420 indicating whether the stir-fry process is complete. This output may be a binary classification (done/not done), or may be a probability or confidence score. Controller module 118 (FIG. 1) may use the output 420 to determine whether to terminate the cooking process, transition to a final stirring or cooling phase, or notify the user via GUI 248.

The model output 420 may be updated continuously at each inference time operation as new sensor and image data becomes available. This enables real-time dynamic response to changing cooking conditions, including under- or over-heating, user intervention, or environmental power fluctuation (as shown in the temporal response charts in FIGS. 3A-3C).

The architecture 402 may thereby enable the system to jointly reason across time-series thermal data, real-time visual information, and contextual ingredient input to make reliable determinations about cooking progress. The use of separate LSTM and CNN branches may ensure that both temporal and spatial features are captured independently before being fused for high-confidence classification. Further variations, including alternative neural topologies, training methods, and confidence thresholds, are described in further detail below.

For example, neural network architecture 402 described above may be implemented using one or more deep learning models that are trained to analyze multimodal input data and determine a cooking status classification. The architecture may leverage temporal dynamics, visual state, and ingredient metadata to predict whether a cooking operation—such as stir-frying—is complete.

Neural network 402 may comprise a hybrid architecture that includes a sequence modeling branch implemented using an LSTM (or gated recurrent unit (GRU)), and a spatial feature branch implemented using a CNN. A third input, representing ingredients or recipe-specific parameters, may be encoded into a vector space and fused with the outputs of the other branches.

LSTM 410 may include temporal modeling processing. Such processes may include analyzing time-series input data including sensor-derived features collected over time intervals t₀ to tₙ (404-408). As described previously, such feature vectors may include one or more of: maximum temperature (e.g., upper bound from pot sensor array), median temperature (e.g., trimmed mean or statistical median); minimum or ambient temperature, power usage (e.g., instantaneous or average wattage), humidity, fan status, stirring motor RPM, or ingredient density estimation. Some, all, or individual feature vectors may be normalized (e.g., Z-score normalization or min-max scaling) before being passed to LSTM 410. LSTM network may include one or more layers of memory cells, with hidden states and forget gates tuned to model one or more of: phase transitions (e.g., post-oil cooling dip), non-linear re-heating behavior, ingredient-dependent thermal signatures, and/or effects of environmental constraints (e.g., power ramping delays under constrained power scenarios).

The time-series data processed by LSTM module 410 may include both contact-based pot temperature measurements and non-contact surface temperature readings acquired via the top-mounted infrared sensor. Such values may be aligned and fused to form a composite temperature feature vector representing both structural and surface-level thermal dynamics during the cooking process. Thus, thermal data may include a non-contact surface temperature measurement acquired via an infrared sensor positioned above the cooking vessel.

LSTM module 410 may receive a time-series vector that may include power output values from the heating element, in addition to temperature readings and motor current feedback. Such power values may provide a temporal view of energy delivery throughout the cooking session and allow the model to detect control patterns and adapt heating schedules based on learned behaviors. Variations in power output may also serve as indirect indicators of external constraints or thermal saturation states.

Accordingly, sensor data may include a power output measurement from a heating element of the cooking robot. The power output measurement may be used to determine the cooking state. Determining the cooking state may comprise combining at least infrared pot temperature, heating element power output, image features, and ingredient information into a unified feature vector used as input to a classification model.

The LSTM model may be pre-trained on labeled historical cooking sessions using a sequence-to-label or sequence-to-sequence formulation. Labeling may be performed based on known ground-truth time points at which a cooking task (e.g., stir-fry) was considered complete by an expert user. The final output of LSTM 410 may be a fixed-size hidden state vector 412, which may encode the learned representation of the cooking trajectory up to time tₙ.

The time-series input to LSTM module 410 may include a spatial temperature profile generated from a plurality of temperature sensors coupled to a rotatable cooking vessel. The spatial temperature profile may include temperature values indexed by angular position, regional temperature gradients, angular sector temperatures, rates of regional temperature change, rotation speed, rotation direction, and heating-source actuation values. The LSTM module may learn temporal patterns in the spatial temperature profile, including localized cooling caused by ingredient addition, uneven heating caused by ingredient distribution, and recovery behavior in response to actuation of one or more heating sources.

CNN module 413 may receive an input image 411 captured by one or more RGB or thermal cameras positioned above the cooking pot (see sensors 244 in FIG. 2C). The image may depict visual cooking indicators such as: browning level, color uniformity, oil shimmering, ingredient moisture content or surface dryness, presence of smoke or steam, and/or ingredient movement or texture deformation.

CNN module 413 may be implemented as a lightweight architecture (e.g., MobileNet, ResNet-18) to support fast inference latency. Preprocessing may include: resizing to 256×256 or 224×224 pixels, normalization to zero-centered RGB range, and/or masking or region of interest (ROI) selection (e.g., cropping to pot region). CNN module 413 output may be a dense image feature embedding 416, which may represent high-level visual semantics learned during supervised training. CNN 413 may be trained jointly with LSTM 410 using a shared loss function, or separately using classification labels such as doneness levels (“raw,” “browning,” “ready”).

### Ingredient Metadata Encoding

Ingredients one-hot vector 414 may represent categorical and/or quantitative information about the current cooking session. This input may include: one-hot encoding of ingredient class (e.g., tofu, chicken, kale, onion), encoded cooking profile (e.g., fragile, high oil absorption, browning), optional numeric inputs: ingredient weight, water content, oil ratio, salt/sugar ratio, and/or recipe phase indicator: predefined cooking plan operations or expected target temperature curve. Such input may allow the model to adjust its interpretation of temperature and visual features based on ingredient expectations. For example, a browning color may indicate “done” for meat, but not for root vegetables.

The outputs of the LSTM (hidden vector 412), the CNN (image embedding 416), and the ingredient module (vector 414) may be fused in a concatenation layer, which may include normalization or dropout layers to improve generalization. Fusion may be followed by a fully connected linear layer 418 that may output a scalar or softmax probability vector. The final output 420 may represent: a binary label (e.g., cooking done/not done), a multiclass label (e.g., rare, medium, well-done), and/or a real-valued doneness confidence score (e.g., 0.0-1.0). The output 420 may be used by controller module 118 to transition cooking robot 240 from active heating to idle, initiate a cool down sequence, or alert the user via GUI 248.

### Model Training

Training of the model may be conducted using a labeled dataset of cooking sessions, including one or more of: time-aligned sensor data streams (temperature, power), corresponding RGB/thermal images at known timestamps, ingredient annotations (either from recipe input or visual/scale detection), completion labels (manually confirmed or based on user feedback). Loss functions may include: binary cross-entropy (for classification), mean squared error (for doneness confidence prediction), auxiliary losses (e.g., early stopping penalties, temperature target deviation), regularization may include data augmentation (e.g., image noise, blur), dropout layers, or domain adaptation if deployed across diverse cooking environments.

Architecture 402 may be extended or modified to include reinforcement learning modules that adjust control policies based on reward signals (e.g., user satisfaction, ingredient waste minimization). Transformer-based sequence models may be used as alternatives to LSTM for longer-term cooking state prediction. Feedback loops from post-cook visual assessments (e.g., user captures post-fry image to validate output) may be used to fine-tune CNN weights. Personalization layers, where user history or preference vectors are fused into the architecture (e.g., user prefers extra crispy doneness), may be used. Such modeling may also be distributed across edge (robot-side) and cloud (server-side) components, with LSTM inference occurring locally and CNN processing occurring on server 102 for bandwidth optimization.

System 100 may be implemented as an end-to-end multimodal learning architecture in which raw time-series sensor data, image data, and ingredient metadata may be directly mapped to control decisions without intermediate manual tuning or hard-coded rules. This design may allow the system to continuously learn from diverse cooking sessions and generalize across varying ingredients, cooking styles, and environments.

Furthermore, the joint feature space produced by feature fusion module 116 may enable fault-tolerant inference. If one modality becomes unreliable—such as occlusion in the visual data or temporary power fluctuations—the remaining modalities may continue to support accurate classification. The network may be trained with modality dropout or noise augmentation to improve resilience, allowing controller 118 to maintain robust control even in the presence of degraded input. Accordingly, system 100 may include a machine learning model configured to operate in a fault-tolerant manner by producing a valid cooking state classification when one or more data inputs are partially, or fully, degraded or unavailable.

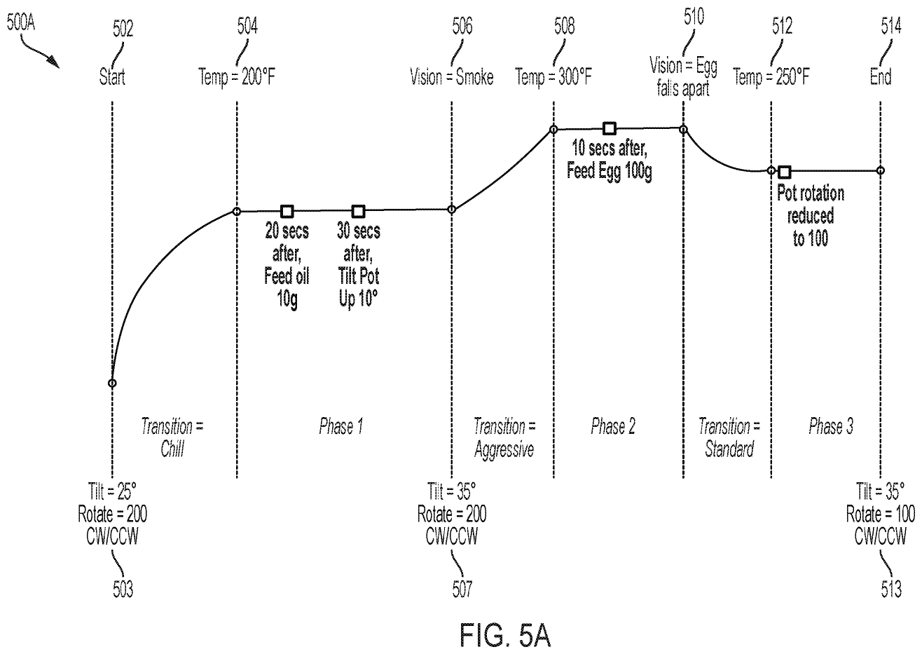

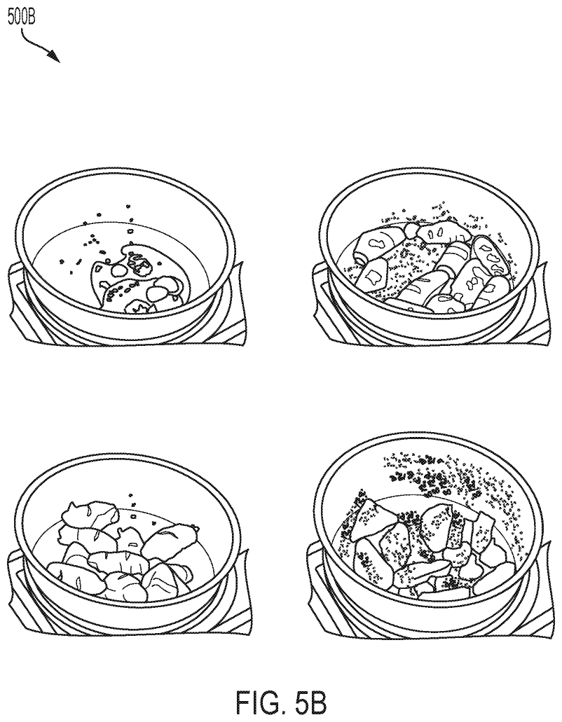

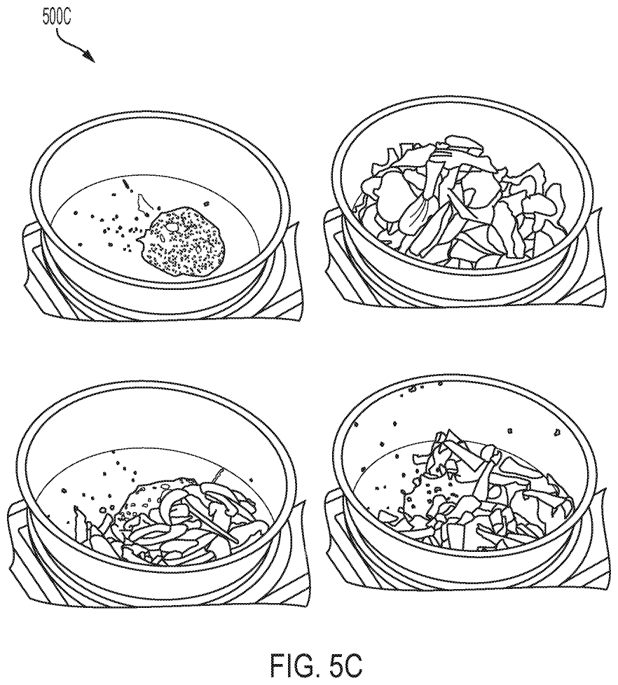

Referring now to FIG. 5A, FIG. 5A depicts a time-resolved cooking control sequence 500A, showing an example stir-fry cooking process divided into discrete operations and phases. The control logic at each operation may be informed by real-time sensor feedback and inference results produced by the neural network architecture 402 described in FIG. 4. These decisions may be executed by controller 118 (FIG. 1) based on fused input from LSTM module 410, CNN module 413, and/or ingredients module 112.

Cooking robot 240 may initiate the process at operation 502, which may mark the start of the cooking session. Initial temperature readings from pot temperature sensors 256 may be transmitted to data collection module 108 and formatted as time-series input vectors 404-408 (FIG. 4). These vectors may be processed by LSTM module 410 to form hidden vector 412.

At operation 504, temperature sensors may detect that the internal pot temperature has reached approximately 200 °F. Based on this detection, controller 118 may initiate Phase 1, characterized by “Transition=Chill.” In this transition state, the mechanical configuration of the cooking vessel may be set to a tilt angle of 25° and a rotation speed of 200 CW/CCW (operation 503). These values may be selected to provide gentle heating and agitation suitable for early-stage cooking.

Following such stabilization, controller 118 may execute two sequential automated operations during Phase 1. First, at 20 seconds after temperature stabilization, a feeding event may be initiated to dispense 10 g of oil into the cooking pot. This operation may be triggered by a pattern recognized by LSTM module 410 based on prior learned sequences. Second, at 30 seconds post-temperature hold, a mechanical tilt adjustment may increase the tilt angle by 10°, using actuation from mechanical units 254. These control decisions may be informed by output 420 generated by the neural network in FIG. 4, which may fuse hidden vector 412, ingredient vector 414, and/or image embedding 416 derived from CNN module 413.

At operation 506, the system may identify the presence of smoke above the cooking surface. This visual cue may be detected using AI cameras (e.g., camera A or B in FIG. 2C), and analyzed by CNN module 413 to extract features such as plume formation, vapor patterns, or luminance changes. These may be embedded into image feature vector 416 and contribute to a fused decision via feature fusion module 116. Recognition of smoke may trigger a transition to Phase 2, labeled as “Aggressive,” with a tilt increase to 35° and continued high-speed rotation at 200 RPM (operation 507).

At operation 508, temperature sensors may report that the pot has reached 300 °F. Based on this condition and prior visual observations, controller 118 may execute another ingredient addition: 100 g of egg. This event may be aligned with a model-predicted window based on training data, where similar temperature and timing patterns were correlated with optimal egg integration.

At operation 510, the system may detect that the egg structure has begun to disintegrate, a visual indicator interpreted by CNN module 413. This feature—captured in the image embedding 416—reflects changes in shape uniformity, edge definition, and surface reflectivity. These features, when evaluated in context with the temperature vector from LSTM module 410 and active ingredient metadata 414, may cause output 420 to indicate readiness for Transition=Standard and enter Phase 3.

At operation 512, a temperature drop to approximately 250 °F is detected. This cooling behavior—consistent with heat absorption or moisture release—may be registered by temperature sensors 244 and processed by LSTM module 410. Controller 118 may respond by reducing pot rotation to 100 RPM while maintaining tilt at 35° (operation 513), providing a more stable finishing environment for delicate ingredient surfaces.

At operation 514, the cooking process may be determined to be complete based on inference from output 420. This may occur when the model output exceeds a confidence threshold indicating doneness, or based on convergence of multimodal sensor readings (thermal and/or visual) that match a trained end-state pattern.

Thus, each operation in FIG. 5A may exemplify the real-time coordination of AI modules and physical control units. The table below summarizes the contributing components:

| | | Hardware/ |
|---|---|---|
| Operation | AI Module | Execution |
| Range | (FIG. 4) | (FIGS. 1-2) |
| 502-504 | LSTM 410, | Temp sensors 256, |
| | sensors 244 | controller 118 |
| 504-506 | LSTM 410 + | Controller 118, |
| | CNN 413 | mechanical units |
| | | 254 |
| 506 | CNN 413 → image | AI cameras |
| | embedding 416 | (FIG. 2C) |
| 508-510 | Full model (412 + | Controller 118 |
| | 414 + 416 → 420) | triggers egg feed |
| 512-514 | Output 420 | Motor speed |
| | threshold reached | adjusted, process |
| | | ends |

Such procedural sequence demonstrates the intelligent, sensor-driven nature of the cooking robot system, in which multimodal AI inference governs each action and adapts dynamically based on real-time feedback and training-informed expectations.

Referring now to FIG. 5B, a series of real-time cooking states 500B may be shown as captured by cameras (e.g., AI camera A or B) integrated into cooking robot 240 (see FIG. 2C). The images in 500B may correspond to different stages of a meat-based stir-fry cooking process and may be used as input frames 411 for CNN module 413 (FIG. 4).

The upper-left image may depict an early-phase state where oil and aromatics (e.g., ginger, garlic) have just been added. CNN module 413 may extract features such as: low bubble density, oil clarity, minimal surface disruption. Such features suggest the beginning of heating and may be interpreted by controller 118 (FIG. 1) as a preparatory state prior to ingredient loading.

The upper-right image may show partially browned meat, with moderate oil bubbling and visible steam. CNN module 413 may process this image to identify: surface protein denaturation, color changes from raw pink to light brown, moisture release or early evaporation. This image may correspond to operations similar to 506 or 508 in FIG. 5A, and may form part of the image embedding 416, used in fusion with LSTM outputs to drive control adjustments.

The bottom-left image may depict raw meat placed into the pot, corresponding to the post-oil phase described at operation 508 in FIG. 5A. Visual features at this stage include: pale meat surfaces, high contrast against oil background, lack of char or browning indicators. The bottom-right image shows meat that has reached a high degree of browning, with caramelization and glaze build-up visible on the surface. CNN module 413 may detect these doneness indicators through: saturated dark regions, oil film thickness and texture changes, and/or ingredient edge crisping and contraction.

The final image may contribute to output 420 crossing the model's doneness threshold, prompting controller 118 to enter a cooling or ending phase as shown in operation 514 of FIG. 5A. The full sequence in FIG. 5B may also be used as a training sequence, where each image may be annotated with a cooking state label and time-aligned with sensor data. This enables supervised training of CNN module 413 to recognize visual cues associated with each cooking stage.

Referring now to FIG. 5C, another visual cooking progression 500C is shown, illustrating a stir-fry process involving leafy vegetables and mushrooms. These frames highlight how different ingredient classes present different visual characteristics during cooking, which are captured and interpreted by the system in real time.

The upper-left image shows oil preheating, with visible microbubbling and dark seasoning particles, which may be used by CNN module 413 to determine readiness for ingredient insertion. The upper-right image shows leafy greens (e.g., spinach, bok choy) freshly added to the pot. This image may help the model assess: initial volume and leaf integrity, oil coverage and ingredient dispersion, lighting conditions and image contrast. The one-hot encoded ingredient vector 414 provided by ingredients module 112 may indicate “leafy vegetable” class, influencing how image features are weighted during fusion.

The bottom-left image illustrates mushrooms in a partially cooked state, where foam, edge curling, and water release are visible. CNN module 413 may extract features such as: texture swelling, sudden sheen changes, transition from white to tan coloring. Such inputs may provide ingredient-specific visual feedback for LSTM-driven heat prediction and fusion-based doneness inference.

The bottom-right image shows a late-stage condition, where the greens have softened, darkened in color, and begun to shrink. The CNN model may recognize: leaf wilting, high translucency, and/or darkening of chlorophyll. Such image state may correlate with operations similar to 510-514 in FIG. 5A. The model may use such images—along with sensor inputs from temperature sensors 256 and LSTM-derived vector 412—to generate output 420 that signals near-completion of the cooking process.

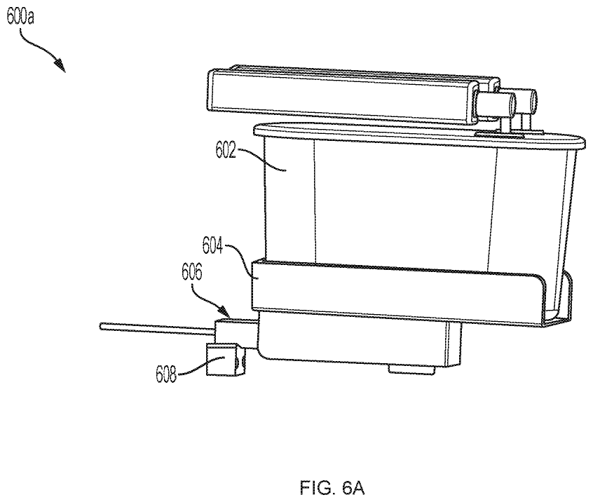

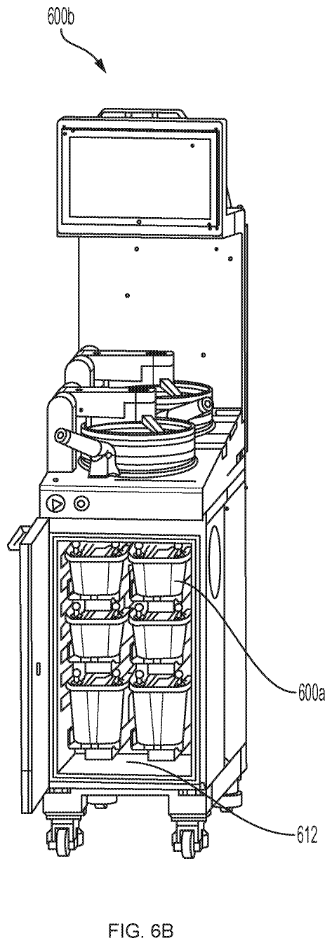

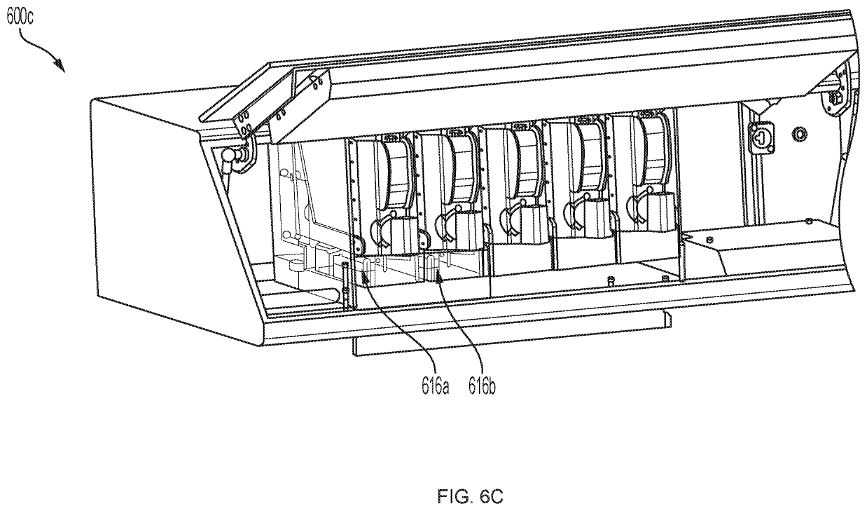

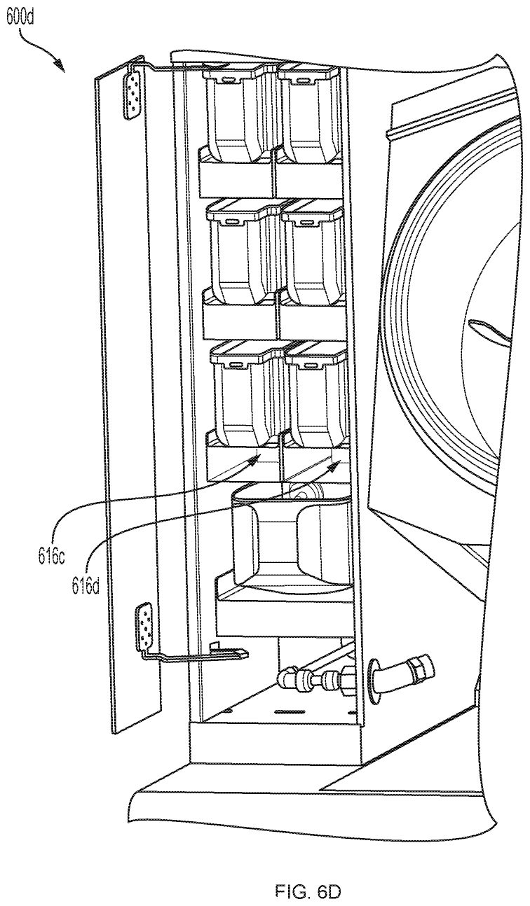

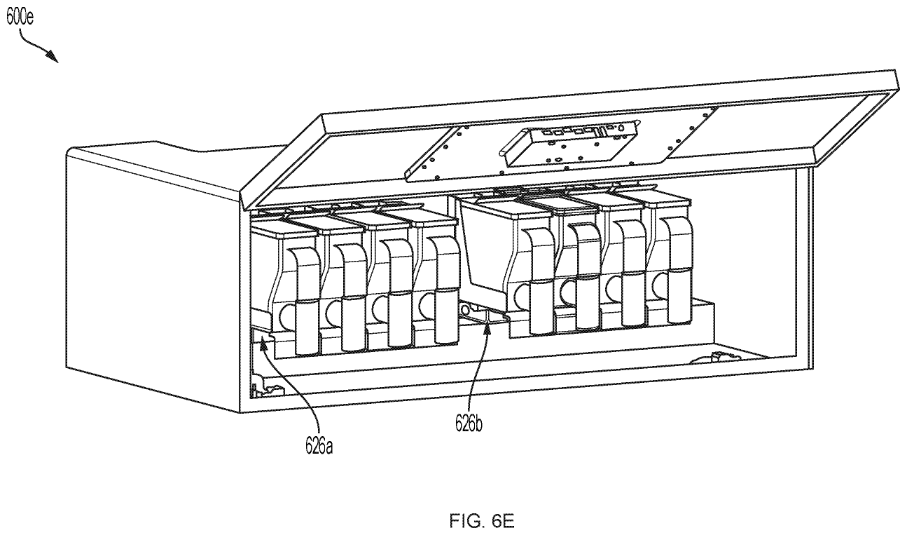

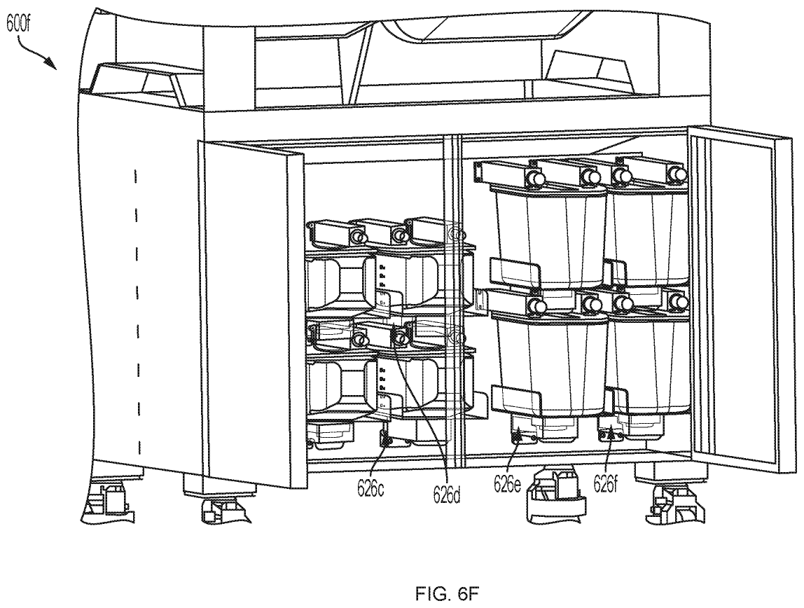

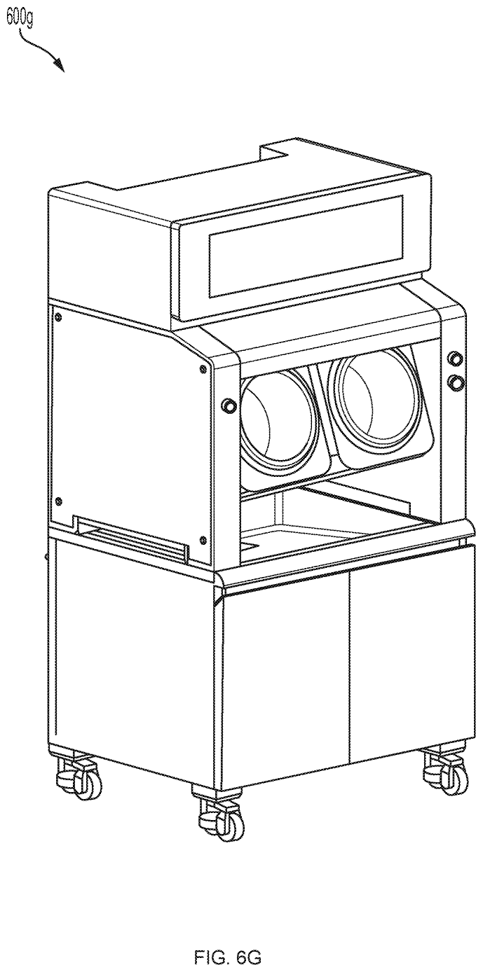

Referring now to FIG. 6A, FIG. 6A illustrates an ingredient dispenser 600a. The ingredient dispenser 600a may include one or more source containers 602 that may store ingredients that may be dispensed into a cooking vessel. The ingredients may include, for example, dry ingredients, granular ingredients, powdered ingredients, liquid ingredients, viscous sauces, oils, seasoning, salts, sugars, spices, marinades, or the like.

The ingredient dispenser 600a may include a dispenser that may dispense an ingredient from a source container 602. For dry ingredients, the dispenser may include one or more of a gravity-fed dispenser, a gate, a valve, an auger, a screw conveyor, a vibration feeder, a chute, a metering wheel, a rotating drum, or the like. For liquid ingredients, the dispenser may include a pump, peristaltic pump, piston pump, diaphragm pump, valve-controlled reservoir, or the like.

The ingredient dispenser 600a may include a scale 606 or load cell that may measure a weight for the ingredient. The scale 606 may be coupled to the source container 602 (e.g., positioned below the source container 602). The scale 606 may measure a decrease in weight of the source container 602 when an ingredient is dispensed. Alternatively or in addition, the scale 606 may measure an increase in weight of a receiving container or cooking vessel. One or more scales 606 may be used to measure source-container subtraction and/or receiving container addition.

A processing device may determine a selected amount of the ingredient to be dispensed. The selected amount of the ingredient to be dispensed may be based on one or more of a recipe, a user input, a cooking state, an ingredient quantity, or the like. The processing device may determine a dispensing duration based on a calibration parameter for the ingredient and actuate the dispenser for the dispensing duration. The processing device may receive, from the scale 606, data representing the weight difference for the ingredient. The processing device may determine a dispensed amount based on the weight difference. The processing device may adjust the calibration parameter based on a difference between the selected amount and the dispensed amount. The processing device may adjust the calibration parameter for subsequent dispensing operations.

The calibration parameter may include a time-to-weight ratio, flow-rate estimate, pump-rate value, auger-rate value, gate-open duration coefficient, density estimate, viscosity estimate, correction factor, lookup-table value, or model parameter for a particular ingredient, ingredient container, dispenser, environmental condition, or recipe. The calibration parameter may be stored locally at the cooking robot, at server 102, at server 242, or in remote resources 150.

The calibration parameter may not be adjusted after every dispensing event. Rather, the processing device may accumulate dispensing feedback over multiple dispensing events or until a threshold amount of ingredient has been dispensed. The threshold may be, for example, about 10 grams for a dry seasoning or about 50 grams for a wet ingredient, or any other suitable threshold. This may reduce the noise from individual scale readings.

The scale 606 may be sampled periodically when no dispensing operation has occurred. A detected increase in weight of a source container 602 may indicate replenishment, replacement, refilling, or the like of a source container 602. The processing device may reset a calibration parameter when replenishment occurs.

The ingredient dispenser 600a may include a box tray 604 that may be coupled to the source container 602. The ingredient dispenser 600a may include a mounting bracket 608 that may position the scale 606.

For example, a recipe may include 10 grams of salt. The processing device may determine, based on a stored calibration parameter, that a dry seasoning dispenser may be actuated for a first duration. After actuation, a scale may detect that 9 grams were dispensed. The controller may store the 1-gram error and, after one or more additional dispensing events or after a threshold cumulative amount has been dispensed, may adjust the calibration parameter so that a subsequent request for 10 grams results in a longer dispensing duration.

In another example, a sauce pump may be calibrated by actuating the pump for a calibration interval and measuring the decrease in weight of a sauce container. The processing device may determine a pump flow rate for the sauce and use the flow rate to calculate dispensing durations for subsequent recipe operations. If the sauce viscosity or pump performance changes over time, the processing device may update the calibration parameter based on measured weight differences.

The calibration parameter may be updated by calculating an observed dispensing rate equal to the measured dispensed amount divided by the dispensing duration. The observed dispensing rate may be combined with a previously stored dispensing rate using a weighted average, moving average, or smoothing function. A future dispensing duration may be calculated by dividing a selected target amount by the updated dispensing rate.

As illustrated in FIG. 6B, the ingredient dispenser 600a may be located in a refrigerator 612 of a cooking system 600b. As illustrated in FIGS. 6C and 6D, an ingredient dispenser 600c may include one or more scales 616a, 616b. The scales 616c, 616d may be integrated with a cooking system 600d. As illustrated in FIGS. 6E-6G, scales 626a, 626b may be included in an ingredient dispenser 600e. Scales 626c, 626d, 626e, 626f may be integrated with cooking system 600f or cooking system 600g.

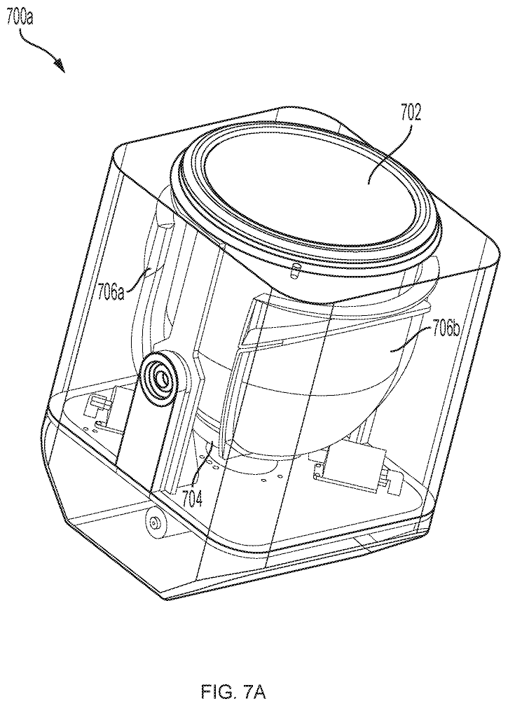

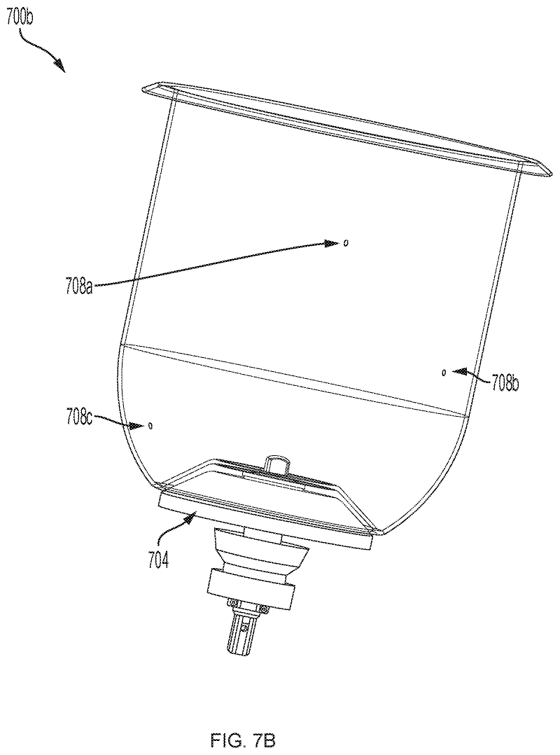

Referring now to FIGS. 7A-7B, temperature sensing and heating control for a rotatable cooking vessel is provided. A cooking assembly 700a, 700b may include a rotatable cooking vessel 702, one or more data processing modules 704, one or more heating sources 706a, 706b, and/or one or more temperature sensors 708a, 708b, 708c. The one or more temperature sensors 708a, 708b, 708c may include three or more temperature sensors that may be spaced apart from one another to sense temperatures at different regions of the cooking vessel.

The one or more temperature sensors 708a, 708b, 708c may be embedded in a wall, base, sidewall, cooking surface, support structure, or thermally conductive portion of the rotatable cooking vessel 702. The one or more temperature sensors 708a, 708b, 708c may include thermocouples, thermistors, resistance temperature detectors, semiconductor temperature sensors, infrared sensors, or other thermal sensing devices. The one or more temperature sensors 708a, 708b, 708c may rotate with the rotatable cooking vessel 702 such that temperature readings may be captured from different angular positions of the rotatable cooking vessel 702 during rotation.

The data processing module 704 may include or be coupled to a wireless communication device that may transmit temperature data from the rotatable cooking vessel 702 to a processing device, such as server 102, local server 242, or another processing device of cooking robot 240. The wireless communication device may communicate using Bluetooth®, Wi-Fi®, near-field communication, ultra-wideband, proprietary radio, inductive telemetry, or another suitable wireless communication protocol. The temperature data may be transmitted using slip rings, rotary connectors, wired connections, optical links, or other communication paths.

The processing device may receive rotation data associated with the rotatable cooking vessel 702. The rotation data may include angular position, angular velocity, rotation frequency, motor encoder data, timing data, direction of rotation, or commanded rotation speed. The processing device may associate temperature readings from the one or more temperature sensors 708a, 708b, 708c with corresponding angular positions of the rotatable cooking vessel 702. Based on the temperature readings and angular positions, the processing device may generate a spatial temperature profile of the rotatable cooking vessel 702.

The spatial temperature profile may represent a one-dimensional, two-dimensional, or three-dimensional thermal map of the rotatable cooking vessel 702. The spatial temperature profile may include temperature values associated with angular sectors, radial positions, height positions, bottom-surface regions, sidewall regions, or combinations thereof. For example, where three temperature sensors are spaced about 120 degrees apart and the rotatable cooking vessel 702 rotates at about one rotation per second, the controller may generate a substantially circumferential temperature profile within approximately one second. Other sensor counts, spacing patterns, and rotation rates may also be used. For example, two, four, five, six, eight, ten, or more temperature sensors arranged at equal or unequal angular spacing may be used. Sensors may also be arranged at different radial or vertical positions to capture bottom-surface temperature, sidewall temperature, rim temperature, or other vessel regions.

The cooking system may include one or more heating sources 706a, 706b positioned to heat different regions of the rotatable cooking vessel 702. The heating sources 706a, 706b may include induction heating coils, resistive heaters, gas burners, infrared heaters, radiant heaters, forced-air heaters, or combinations thereof. The heating sources may be independently controllable, partially independently controllable, or grouped into zones. The controller may actuate the heating sources based on the spatial temperature profile to increase heat in a cooler region, reduce heat in an overheated region, compensate for temperature drops caused by cold ingredient addition, maintain a desired thermal gradient, or execute a recipe-specific heating profile.

The spatial temperature profile may be used as an input to LSTM module 410 or another temporal model. For example, the spatial temperature profile may be converted into a time-series feature vector including regional temperature values, maximum temperature, minimum temperature, median temperature, temperature variance, angular temperature gradients, rate of temperature change, heating-source power values, pot rotation speed, and/or pot rotation direction. The LSTM model may process this enhanced thermal feature vector to determine a cooking state, predict a future cooking state, or generate information used by controller module 118 to control heating, stirring, rotation, tilt, or dispensing.

The processing device may divide the rotatable cooking vessel 702 into angular zones, map temperature readings into the angular zones, compare the temperature of each zone to a target thermal profile, and determine heating-source commands based on a zone-specific temperature error. The heating-source commands may include power level, duty cycle, activation timing, or heating-source selection. The processing device may update the commands during successive rotations of the vessel to provide closed-loop control of the vessel temperature profile.

In one example, cold rice may be introduced into a rotatable cooking vessel 702. Multiple temperature sensors may detect a localized temperature drop in a region of the rotatable cooking vessel 702. The processing device may associate the temperature drop with angular position data and update a spatial temperature profile. Based on the spatial temperature profile, the controller may increase power to one or more heating sources positioned to heat the cooler region while maintaining or reducing power to another heating source associated with a region already at target temperature.

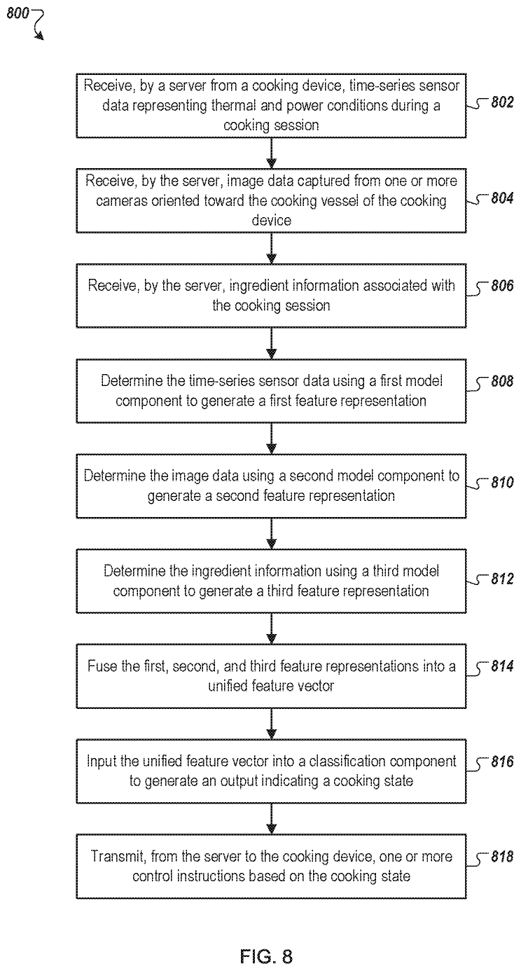

Referring now to FIG. 8, FIG. 8 illustrates a method 800 for controlling a cooking process using a machine learning-based system architecture. The method may be implemented using the system shown and described in FIGS. 1-5, including server 102/242, cooking robot 240, and the neural network architecture 402.

Method 800 begins at operation 802, where a server receives time-series sensor data from a cooking device. The sensor data may include thermal and power-related measurements such as pot temperature (contact-based sensor 256 and infrared sensor 244), ambient air temperature, and heating element power output, as shown and described in FIGS. 2B-2C. This data may also include current feedback from the stirring motor, which reflects food resistance or texture. These inputs may be collected by data collection module 108 of server 102 and may be used as input to LSTM module 410 as shown in FIG. 4.

At operation 804, the server receives image data captured from one or more cameras oriented toward the cooking vessel. As illustrated in FIGS. 2A-2C, each cooking robot 240 may include an RGB camera and a thermal camera mounted at the top of the unit, positioned to provide a direct view of the ingredients during cooking. These cameras may capture visual and thermal imagery in real time. The image data may be used by CNN module 413 (FIG. 4) to extract visual features related to doneness, color change, smoke, surface moisture, and other indicators of cooking state.

In operation 806, the server may receive ingredient information associated with the cooking session. This information may be entered manually by the user through user interaction module 124, determined automatically by sensors such as weight sensors or digital ingredient dispensers (FIG. 2C), or retrieved from a stored recipe database. Ingredient information may include ingredient type, class (e.g., vegetable, protein), quantity, or cooking profile, and may be encoded via one-hot or similar encoding using ingredients module 112 (FIG. 1) and represented as ingredient vector 414 in FIG. 4.

In operation 808, the time-series sensor data may be processed using a first model component—specifically LSTM module 410 of FIG. 4—to generate a first feature representation. The LSTM network may be trained to detect cooking patterns from historical time-series input, such as how temperature and power evolve over time, and may output a hidden vector (412) representing these learned temporal dynamics.

At operation 810, the image data may be processed using a second model component—specifically CNN module 413—to generate a second feature representation. The CNN extracts spatial features from image input 411, such as texture, color, shape, and visual transitions like bubbling, caramelization, or food breakdown. The output of this process forms image feature embedding 416.

In operation 812, the ingredient information may be processed using a third model component to generate a third feature representation. This may include one-hot encoding or embedding lookup for ingredient attributes, as implemented via ingredients module 112, producing ingredient vector 414.

In operation 814, the system may fuse the first, second, and third feature representations into a unified feature vector. This may occur via feature fusion module 116 (FIG. 1 and FIG. 4), which may align and combine the LSTM hidden vector 412, image embedding 416, and/or ingredient vector 414 into a joint representation. As described above in FIG. 4, this fusion operation may create a joint feature space that may support robust and fault-tolerant inference by allowing redundancy between visual, temporal, and ingredient-related signals.

At operation 816, the unified feature vector may be input into a classification component—e.g., a dense layer or fully connected network 418 in FIG. 4—to generate an output 420 indicating the current cooking state. The output may be binary (e.g., stir-fry is done/not done) or multi-class (e.g., preheat, fry, add salt, done), and may be computed with confidence scores that inform probabilistic control logic.

At operation 818, the server may transmit one or more control instructions to the cooking device based on the determined cooking state. These control signals may be executed by controller 118 (FIG. 1) and may include instructions to adjust heating power, stir speed, pot tilt (see actuators in FIG. 2C), or trigger ingredient dispensing. These decisions may correspond to transitions described in FIG. 5A (e.g., from “Phase 1” to “Phase 2”) and may also be visualized in changes over time as shown in FIGS. 3A-3C. Operations 802-818 may be repeated at regular time intervals throughout the cooking process, forming a continuous closed-loop feedback system for real-time adaptive cooking control.

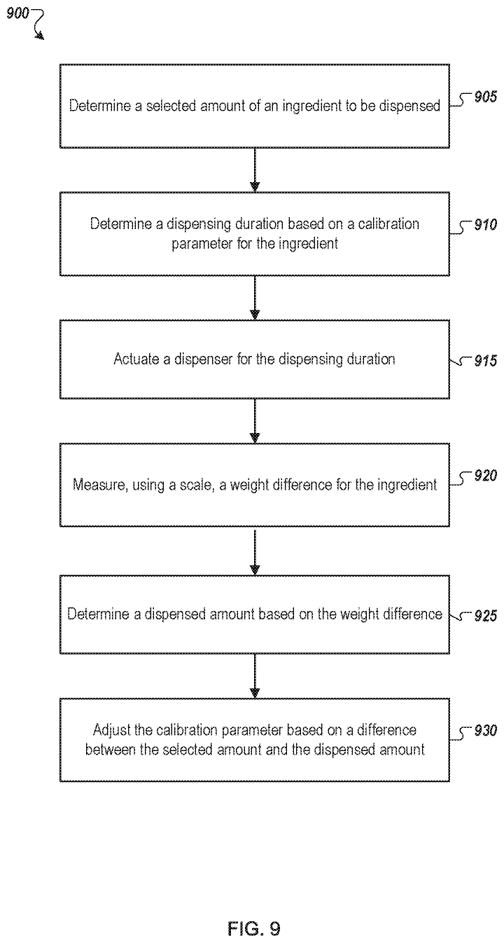

Referring now to FIG. 9, FIG. 9 illustrates a method 900 for calibrating an ingredient dispenser of a cooking system. Method 900 may be performed by server 102, local server 242, controller module 118, ingredients module 112, or another processing device of cooking robot 240.

In operation 905, the system may determine a selected amount of an ingredient to be dispensed. The selected amount may be based on a recipe, a user input, a cooking state, a model output, or an automatically modified recipe generated based on ingredient load or user preference.

In operation 910, the system may determine a dispensing duration based on a calibration parameter for the ingredient. The calibration parameter may represent an estimated amount of ingredient dispensed per unit time, an estimated dispenser flow rate, a pump coefficient, a dry-feed coefficient, a density-adjusted dispensing value, or another relationship between dispenser actuation and dispensed amount.

In operation 915, the system may actuate a dispenser for the dispensing duration. The dispenser may include a pump for liquid ingredients or a gravity-fed dispenser, gate, valve, auger, screw conveyor, vibration feeder, chute, or other dispensing mechanism for dry ingredients.

In operation 920, the system may measure, using a scale, a weight difference for the ingredient. The weight difference may be determined from a decrease in weight of a source container. The weight difference may be determined from an increase in weight of a receiving container or cooking vessel.

In operation 925, the system may determine a dispensed amount based on the weight difference. The dispensed amount may be compared with a selected amount to determine an error value.

In operation 930, the system may adjust the calibration parameter based on a difference between the selected amount and the dispensed amount. The calibration parameter may be adjusted after a threshold amount of ingredient has been dispensed, after a threshold number of dispensing events, or when a measured error exceeds a threshold. The calibration parameter may be updated using a moving average, weighted average, regression, lookup table, proportional correction, or other calibration update technique.

The system may detect replenishment of the ingredient based on an increase in weight for a container storing the ingredient.

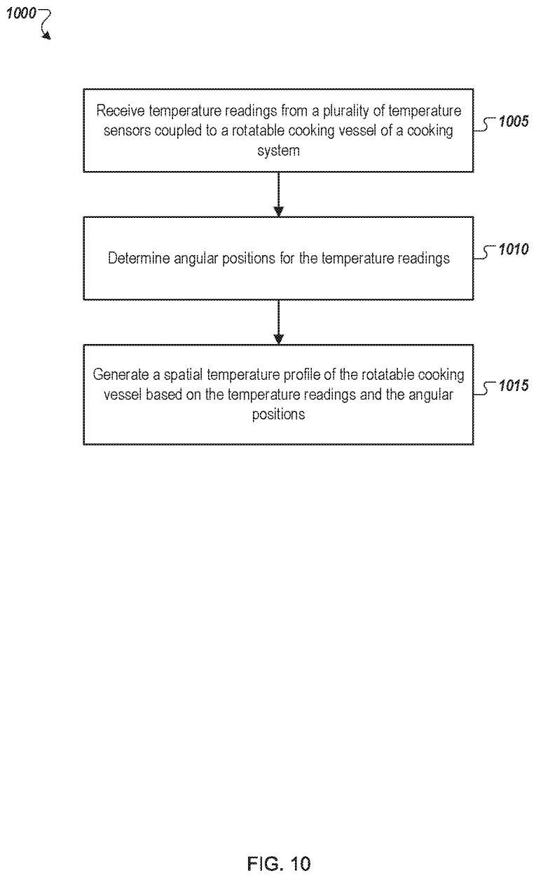

Referring now to FIG. 10, FIG. 10 illustrates a method 1000 for generating a spatial temperature profile of a rotatable cooking vessel. Method 1000 may be performed by a server 102, local server 242, controller module 118, data collection module 108, LSTM module 110, or another processing component of cooking robot 240.

At operation 1005, the system may receive temperature readings from a plurality of temperature sensors coupled to a rotatable cooking vessel of a cooking system. The temperature sensors may include three or more sensors spaced to sense temperatures from different regions of the cooking vessel.

At operation 1010, the system may determine angular positions for the temperature readings. The angular positions may be determined using encoder data, motor control data, rotation frequency, timing data, sensor location data, inertial data, or other rotation-position information. The system may determine a respective angular position for each temperature reading based on a known sensor position and a current rotational orientation of the cooking vessel.

At operation 1015, the system may generate a spatial temperature profile of the rotatable cooking vessel based on the temperature readings and the angular positions. The spatial temperature profile may be used to determine whether heat is evenly distributed, whether a localized cold region or hot region exists, whether a temperature drop corresponds to ingredient addition, or whether one or more heating sources should be adjusted.

The system may rotate the cooking vessel at a selected frequency to facilitate generation of the spatial temperature profile. The system may actuate two or more heating sources based on the spatial temperature profile. The spatial temperature profile may be input to an LSTM model or other machine-learning model to determine a cooking state or generate control instructions.

The embodiments described herein present a comprehensive, AI-driven cooking control system that integrates real-time sensor data, computer vision, and machine learning to enable dynamic, autonomous cooking operations. By combining thermal feedback, visual state analysis, and ingredient-specific metadata through a hybrid neural network architecture, the system is capable of accurately determining cooking states and executing responsive control actions without the need for continuous human oversight. This multimodal approach enables the system to adapt to varying environmental conditions, ingredient types, and recipe demands with precision and consistency.

The use of a time-series LSTM model for learning cooking patterns, coupled with CNN-based visual analysis and feature fusion techniques, provides a robust framework for evaluating ingredient doneness and managing cooking transitions in real time. Integrated hardware components, including temperature sensors, RGB and thermal cameras, and mechanical actuators, allow the system to carry out fine-grained adjustments to heating, stirring, and ingredient dispensing, as directed by server-side inference modules. The architecture is modular and extensible, allowing for deployment in both consumer and commercial settings and compatibility with a wide variety of cooking hardware.

Accordingly, the disclosed system offers a significant advancement in the field of automated cooking technologies. By leveraging AI to replicate and exceed human decision-making in the kitchen, the system provides a scalable solution for consistent, high-quality cooking results across diverse environments. While various embodiments have been described, it will be appreciated that numerous modifications, enhancements, and alternative configurations may be implemented without departing from the scope of the disclosed invention.

### Examples

Example 1 may include a cooking system comprising: a cooking robot configured to perform one or more cooking operations; a plurality of sensors coupled to the cooking robot and configured to collect data during the cooking operations, the data including one or more of thermal data or image data; a network interface configured to enable communication between the cooking robot and a remote server; and a remote server configured to: receive the data collected by the plurality of sensors; analyze the data to determine a cooking state; and generate and transmit one or more control instructions to the cooking robot based on the determined cooking state.

Example 2 may include the cooking system of Example 1, wherein the cooking robot comprises: a cooking vessel; a heating element thermally coupled to the cooking vessel; and a stirring mechanism configured to agitate ingredients during cooking.

Example 3 may include the cooking system of Example 1, wherein the plurality of sensors comprises: a temperature sensor positioned below the cooking vessel; an infrared sensor configured to measure surface temperature of the ingredients; and a humidity sensor configured to detect moisture levels during cooking.

Example 4 may include the cooking system of Example 1, wherein the plurality of sensors comprises an RGB camera and a thermal camera oriented toward the cooking vessel.

Example 5 may include the cooking system of Example 1, wherein the cooking robot comprises one or more actuators configured to adjust a physical orientation or mechanical movement of the cooking vessel or a stirring component in response to the control instructions.

Example 6 may include the cooking system of Example 1, wherein the remote server comprises a processor and memory storing instructions for executing a machine learning model to determine the cooking state.

Example 7 may include the cooking system of Example 6, wherein the machine learning model comprises a neural network configured to receive sequential thermal data and image data as input.

Example 8 may include the cooking system of Example 7, wherein the neural network includes a Long Short-Term Memory (LSTM) model to process time-series thermal data and a Convolutional Neural Network (CNN) to extract features from the image data.

Example 9 may include a system for controlling a cooking process, the system comprising: a memory storing executable instructions and a machine learning model; and a processor in communication with the memory, wherein the machine learning model includes: a first model component configured to receive and process time-series cooking data to generate a first feature representation; a second model component configured to receive and process image data captured during cooking to generate a second feature representation; a third model component configured to receive ingredient information to generate a third feature representation; a fusion component configured to combine the first, second, and third feature representations into a unified feature vector; and a classification component configured to receive the unified feature vector and generate an output indicating a cooking state, wherein executing the instructions by the processor, configures the system for: receiving the time-series cooking data, the image data, and the ingredient information from a cooking device; determining the cooking state; and transmitting one or more control instructions to the cooking device based on the cooking state.

Example 10 may include the system of Example 9, wherein the first model component comprises a recurrent neural network configured to process sequential temperature and power data.

Example 11 may include the system of Example 10, wherein the recurrent neural network is a Long Short-Term Memory (LSTM) model.

Example 12 may include the system of Example 9, wherein the second model component comprises a convolutional neural network (CNN) configured to extract visual features from an RGB or thermal image.

Example 13 may include the system of Example 9, wherein the third model component is configured to encode ingredient type or quantity using a one-hot vector representation.

Example 14 may include the system of Example 9, wherein the classification component outputs a binary value indicating whether the cooking process is complete.

Example 15 may include the system of Example 9, wherein the processor is further configured to continuously update the cooking state at discrete time intervals based on incoming data from the cooking device.

Example 16 may include the system of Example 9, wherein the control instructions comprise at least one of: adjusting a heating parameter, modifying a stirring parameter, or triggering an ingredient dispensing operation.

Example 17 may include a method for controlling a cooking process using a machine learning model, the method comprising: receiving, by a server from a cooking device, time-series sensor data representing thermal and power conditions during a cooking session; receiving, by the server, image data captured from one or more cameras oriented toward the cooking vessel of the cooking device; receiving, by the server, ingredient information associated with the cooking session; processing the time-series sensor data using a first model component to generate a first feature representation; processing the image data using a second model component to generate a second feature representation; processing the ingredient information using a third model component to generate a third feature representation; fusing the first, second, and third feature representations into a unified feature vector; inputting the unified feature vector into a classification component to generate an output indicating a cooking state; and transmitting, from the server to the cooking device, one or more control instructions based on the cooking state.

Example 18 may include the method of Example 17, further comprising: training the second model component using a dataset of labeled cooking images representing ingredient doneness states.

Example 19 may include the method of Example 17, further comprising updating one or more components of the machine learning model based on feedback from cooking outcomes, including final ingredient condition or user ratings.

Example 20 may include the method of Example 17, wherein the machine learning model includes a reinforcement learning module configured to modify control strategies over time based on accumulated cooking performance rewards.

Example 21 may include a method, comprising: determining a selected amount of an ingredient to be dispensed; determining a dispensing duration based on a calibration parameter for the ingredient; actuating a dispenser for the dispensing duration; measuring, using a scale, a weight difference for the ingredient; determining a dispensed amount based on the weight difference; and adjusting the calibration parameter based on a difference between the selected amount and the dispensed amount.

Example 22 may include the method of Example 21, wherein the ingredient comprises a dry ingredient and wherein the dispenser comprises one or more of a gravity-fed dispenser, a gate, a valve, an auger, a screw conveyor, a vibration feeder, or a chute.

Example 23 may include the method of Example 21, wherein the ingredient comprises a liquid ingredient and wherein the dispenser comprises a pump.

Example 24 may include the method of Example 21, wherein the weight difference is measured by a decrease in weight of a source container storing the ingredient.

Example 25 may include the method of Example 21, wherein the calibration parameter is adjusted after a threshold amount of the ingredient has been dispensed.

Example 26 may include the method of Example 21, further comprising detecting replenishment of the ingredient based on an increase in weight for a container storing the ingredient.

Example 27 may include a device, comprising: a dispenser operable to dispense an ingredient; a scale operable to measure a weight difference for the ingredient; a processing device; a memory storing executable instructions, wherein executing the executable instructions by the processing device causes the device to: determine a selected amount of the ingredient to be dispensed; determine a dispensing duration based on a calibration parameter for the ingredient; actuate the dispenser for the dispensing duration; receive, from the scale, data representing the weight difference for the ingredient; determine a dispensed amount based on the weight difference; and adjust the calibration parameter based on a difference between the selected amount and the dispensed amount.

Example 28 may include the device of Example 27, wherein the ingredient comprises a dry ingredient and wherein the dispenser comprises one or more of a gravity-fed dispenser, a gate, a valve, an auger, a screw conveyor, a vibration feeder, or a chute.

Example 29 may include the device of Example 27, wherein the ingredient comprises a liquid ingredient and wherein the dispenser comprises a pump.

Example 30 may include the device of Example 27, further comprising a source container operable to store the ingredient, wherein the scale is operable to measure the weight difference based on a decrease in weight of the source container.

Example 31 may include the device of Example 27, wherein executing the executable instructions by the processing device causes the device to adjust the calibration parameter after a threshold amount of the ingredient has been dispensed.

Example 32 may include the device of Example 27, further comprising a source container operable to store the ingredient, wherein executing the executable instructions by the processing device causes the device to detect replenishment of the ingredient based on an increase in weight for the source container storing the ingredient.

Example 33 may include a cooking system, comprising: a rotatable cooking vessel comprising a plurality of temperature sensors; a wireless communication device operable to transmit temperature data from the rotatable cooking vessel to a controller; and a plurality of heating sources, wherein the controller is operable to generate a spatial temperature profile of the rotatable cooking vessel.

Example 34 may include the cooking system of Example 33, wherein the plurality of temperature sensors comprises 3 or more temperature sensors.

Example 35 may include the cooking system of Example 33, wherein the plurality of temperature sensors are spaced to sense temperature data from different regions of the rotatable cooking vessel.

Example 36 may include the cooking system of Example 33, wherein the rotatable cooking vessel is operable to rotate at a selected frequency to facilitate generation of the spatial temperature profile.

Example 37 may include the cooking system of Example 33, wherein the plurality of heating sources comprises 2 or more heating sources, wherein the 2 or more heating sources are actuated based on the spatial temperature profile.

Example 38 may include the cooking system of Example 33, wherein the spatial temperature profile is input to a Long Short-Term Memory (LSTM) model to determine a cooking state.

Example 39 may include a method, comprising: receiving temperature readings from a plurality of temperature sensors coupled to a rotatable cooking vessel of a cooking system; determining angular positions for the temperature readings; and generating a spatial temperature profile of the rotatable cooking vessel based on the temperature readings and the angular positions.

Example 40 may include the method of Example 39, wherein the plurality of temperature sensors comprises 3 or more temperature sensors.

Example 41 may include the method of Example 39, wherein the plurality of temperature sensors are spaced to sense temperature data from different regions of the rotatable cooking vessel.

Example 42 may include the method of Example 39, further comprising rotating the rotatable cooking vessel at a selected frequency to facilitate generation of the spatial temperature profile.

Example 43 may include the method of Example 39, wherein the cooking system comprises 2 or more heating sources and further comprising actuating the 2 or more heating sources based on the spatial temperature profile of the rotatable cooking vessel.

Example 44 may include the method of Example 39, wherein the spatial temperature profile is input to a Long Short-Term Memory (LSTM) model to determine a cooking state.

The embodiments described herein may be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages.

Furthermore, any reference to this disclosure in general or use of the word “embodiment” in the singular is not intended to imply any limitation on the scope of the claims set forth below. Multiple embodiments may be set forth according to the limitations of the multiple claims issuing from this disclosure, and such claims accordingly define the embodiment(s) herein, and their equivalents, that are protected thereby.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the description provided above provides detail for the purpose of illustration based on what is currently considered to be the most practical and preferred embodiments, it is to be understood that such detail is solely for that purpose and that the disclosure is not limited to the expressly disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A cooking system comprising:
a cooking robot configured to perform one or more cooking operations;
a plurality of sensors coupled to the cooking robot and configured to collect data during the cooking operations, the data including one or more of thermal data or image data;
a network interface configured to enable communication between the cooking robot and a remote server; and
a remote server configured to:
receive the data collected by the plurality of sensors;
analyze the data to determine a cooking state; and
generate and transmit one or more control instructions to the cooking robot based on the determined cooking state.

2. The cooking system of claim 1, wherein the cooking robot comprises:
a cooking vessel;
a heating element thermally coupled to the cooking vessel; and
a stirring mechanism configured to agitate ingredients during cooking.

3. The cooking system of claim 2, wherein the plurality of sensors comprises:
a temperature sensor positioned below the cooking vessel;
an infrared sensor configured to measure surface temperature of the ingredients; and
a humidity sensor configured to detect moisture levels during cooking.

4. The cooking system of claim 2, wherein the plurality of sensors comprises an RGB camera and a thermal camera oriented toward the cooking vessel.

5. The cooking system of claim 1, wherein the cooking robot comprises one or more actuators configured to adjust a physical orientation or mechanical movement of a cooking vessel or a stirring component in response to the control instructions.

6. The cooking system of claim 1, wherein the remote server comprises a processor and memory storing instructions for executing a machine learning model to determine the cooking state.

7. The cooking system of claim 6, wherein the machine learning model comprises a neural network configured to receive sequential thermal data and image data as input.

8. The cooking system of claim 7, wherein the neural network includes a Long Short-Term Memory (LSTM) model to process time-series thermal data and a Convolutional Neural Network (CNN) to extract features from the image data.

9. A system for controlling a cooking process, the system comprising:
a memory storing executable instructions and a machine learning model; and
a processor in communication with the memory,
wherein the machine learning model includes:
a first model component configured to receive and process time-series cooking data to generate a first feature representation;
a second model component configured to receive and process image data captured during cooking to generate a second feature representation;
a third model component configured to receive ingredient information to generate a third feature representation;
a fusion component configured to combine the first, second, and third feature representations into a unified feature vector; and
a classification component configured to receive the unified feature vector and generate an output indicating a cooking state,
wherein executing the instructions by the processor, configures the system for:
receiving the time-series cooking data, the image data, and the ingredient information from a cooking device;
determining the cooking state; and
transmitting one or more control instructions to the cooking device based on the cooking state.

10. The system of claim 9, wherein the first model component comprises a recurrent neural network configured to process sequential temperature and power data.

11. The system of claim 10, wherein the recurrent neural network is a Long Short-Term Memory (LSTM) model.

12. The system of claim 9, wherein the second model component comprises a convolutional neural network (CNN) configured to extract visual features from an RGB or thermal image.

13. The system of claim 9, wherein the third model component is configured to encode ingredient type or quantity using a one-hot vector representation.

14. The system of claim 9, wherein the classification component outputs a binary value indicating whether the cooking process is complete.

15. The system of claim 9, wherein the processor is further configured to update the cooking state at discrete time intervals based on incoming data from the cooking device.

16. The system of claim 9, wherein the control instructions comprise at least one of: adjusting a heating parameter, modifying a stirring parameter, or triggering an ingredient dispensing operation.

17. A method for controlling a cooking process using a machine learning model, the method comprising:
receiving, by a server from a cooking device, time-series sensor data representing thermal and power conditions during a cooking session;
receiving, by the server, image data captured from one or more cameras oriented toward a cooking vessel of the cooking device;
receiving, by the server, ingredient information associated with the cooking session;
processing the time-series sensor data using a first model component to generate a first feature representation;
processing the image data using a second model component to generate a second feature representation;
processing the ingredient information using a third model component to generate a third feature representation;
fusing the first, second, and third feature representations into a unified feature vector;
inputting the unified feature vector into a classification component to generate an output indicating a cooking state; and
transmitting, from the server to the cooking device, one or more control instructions based on the cooking state.

18. The method of claim 17, further comprising:
training the second model component using a dataset of labeled cooking images representing ingredient doneness states.

19. The method of claim 17, further comprising updating one or more components of the machine learning model based on feedback from cooking outcomes, including final ingredient condition or user ratings.

20. The method of claim 17, wherein the machine learning model includes a reinforcement learning module configured to modify control strategies over time based on accumulated cooking performance rewards.
